(19) United States
(12) Patent Application Publication
(10) Pub. No.: US 2025/0175722 A1
(43) Pub. Date: May 29, 2025

(54) SOLID-STATE IMAGING ELEMENT, IMAGING DEVICE, AND METHOD FOR CONTROLLING SOLID-STATE IMAGING ELEMENT

(71) Applicant: Sony Semiconductor Solutions Corporation, Kanagawa (JP)

(72) Inventor: Yunito Ogasawara, Kanagawa (JP)

(21) Appl. No.: 18/729,097

(22) PCT Filed: Jan. 10, 2023
(86) PCT No.: PCT/JP2023/000270

§ 371 Date: Feb. 14, 2025

(30) Foreign Application Priority Data
Mar. 4, 2022 (JP) 2022-033119

(51) Int. Cl. H04N 25/78; H04N 25/709; H04N 25/79

(52) U.S. Cl. CPC H04N 25/78; H04N 25/709; H04N 25/79

(57) ABSTRACT

Power consumption is reduced in a solid-state imaging element that generates a composite image.

The solid-state imaging element includes a pre-stage circuit, a sample hold circuit, and a determination circuit. The pre-stage circuit generates a pixel signal that is an analog signal a plurality of times. The sample hold circuit holds a level of the pixel signal as a held value, and updates the held value according to a level of a new pixel signal according to a determination signal predetermined. The determination circuit determines whether or not to update the held value and supplies a signal indicating a determination result as the determination signal.

### TECHNICAL FIELD

The present technology relates to a solid-state imaging element. Specifically, the present technology relates to a solid-state imaging element that performs processing on image data, an imaging device, and a method of controlling a solid-state imaging element.

### BACKGROUND ART

Conventionally, a complementary MOS (CMOS) semiconductor manufacturing process can be used, and thus a CMOS image sensor (CIS), which is a solid-state imaging element using a CMOS, is widely used in imaging devices and the like. For example, there has been proposed a solid-state imaging element that generates a trail image of a starry sky or the like by comparative bright combination of a plurality of images (see, for example, Patent Document 1). Furthermore, there has been proposed a solid-state imaging element that combines a plurality of images on the basis of distance information to generate an image focused on a plurality of points (see, for example, Patent Document 2).

### CITATION LIST

### Patent Document

Patent Document 1: Japanese Patent Application Laid-Open No. 2019-121981
Patent Document 2: Japanese Patent Application Laid-Open No. 2019-125928

### SUMMARY OF THE INVENTION

### Problems to be Solved by the Invention

In the related art described above, a trail image of the starry sky and an image focused on a plurality of points are created by combining a plurality of images. However, in the above-described solid-state imaging element, when a composite image is generated by combining a plurality of pieces of image data, it is necessary to generate a plurality of pieces of image data by analog to digital (AD) conversion and to hold one or more pieces of image data in a frame memory or the like. Therefore, as the number of image data to be combined increases, the number of times of AD conversion and the number of times of access to the frame memory increase, and there is a problem that power consumption increases.

The present technology has been made in view of such a situation, and an object thereof is to reduce power consumption in a solid-state imaging element that generates a composite image.

### Solutions to Problems

The present technology has been made to solve the above-described problems, and a first aspect thereof is a solid-state imaging element including: a pre-stage circuit that generates a pixel signal that is an analog signal a plurality of times; a sample hold circuit that holds a level of the pixel signal as a held value and updates the held value according to a level of a new pixel signal according to a determination signal predetermined; and a determination circuit that determines whether or not to update the held value and supplies a signal indicating a determination result as the determination signal, and a control method thereof. This brings about an effect of reducing power consumption of the solid-state imaging element.

Furthermore, in the first aspect, the determination circuit may compare the pixel signal with a predetermined threshold value and supply a comparison result as the determination result. This brings about an effect that the number of times of AD conversion is reduced.

Furthermore, in the first aspect, the pre-stage circuit, the sample hold circuit, and the determination circuit may be arranged in each of a plurality of pixels. This brings about an effect that whether or not to update the held value is determined for each pixel.

Furthermore, in the first aspect, the pre-stage circuit and the sample hold circuit may be arranged in each of a plurality of pixels, a pixel array section in which the plurality of pixels is arranged may be divided into a predetermined number of regions, the determination circuit may be arranged in each of the regions, and the pixels in the region may share the determination circuit corresponding to the region. This brings about an effect that whether or not to update the held value is determined for each region.

Furthermore, in the first aspect, a logic gate that supplies a predetermined scan signal indicating a sample timing and a read timing to the sample hold circuit on the basis of the determination signal may be further included, and the determination circuit may include: a comparator that compares the pixel signal with a predetermined threshold value and supplies a signal indicating a comparison result as the determination signal; and a latch circuit that captures and holds the determination signal at the sample timing and initializes the determination signal at the read timing. This brings about an effect that the circuit of the pixel is simplified.

Furthermore, in the first aspect, a pre-stage logic gate that supplies a predetermined scan signal indicating a sample timing on the basis of the determination signal, and a post-stage logic gate that supplies a logical sum of a predetermined control signal indicating a read timing and an output signal of the pre-stage logic gate to the sample hold circuit may be further included. This brings about an effect that the latch circuit is simplified.

Furthermore, in the first aspect, an analog-to-digital converter that converts the pixel signal into a digital signal may be further included, and the determination circuit may compare the digital signal with a predetermined threshold value and supply a comparison result as the determination result. This brings about an effect that the circuit scale of the pixel is reduced.

Furthermore, in the first aspect, the pre-stage circuit may be arranged on a predetermined first chip, and the sample hold circuit may be arranged on a predetermined second chip. This brings about an effect of facilitating pixel miniaturization.

Furthermore, in the first aspect, the determination circuit may be disposed on the second chip. This brings about an effect that the circuit scale of the first chip is reduced.

Furthermore, in the first aspect, the determination circuit may be disposed on the first chip. This brings about an effect that the circuit scale of the second chip is reduced.

Furthermore, in the first aspect, a post-stage reset transistor that initializes a level of a predetermined post-stage node may be further included, the pre-stage circuit may sequentially generate a predetermined reset level and a signal level corresponding to an exposure amount, the sample hold circuit may include: first and second capacitor elements; and a selection circuit that sequentially performs control to connect one of the first and second capacitor elements to the post-stage node, control to disconnect both of the first and second capacitor elements from the post-stage node, and control to connect another of the first and second capacitor elements to the post-stage node, and the post-stage reset transistor may initialize a level of the post-stage node when both of the first and second capacitor elements are disconnected from the post-stage node. This brings about an effect of reducing kTC noise.

Furthermore, a second aspect of the present technology is an imaging device including: a pre-stage circuit that generates a pixel signal that is an analog signal a plurality of times; a sample hold circuit that holds a level of the pixel signal as a held value and updates the held value according to a level of a new pixel signal according to a determination signal predetermined; and a determination circuit that discriminates whether or not to update the held value and supplies a signal indicating a determination result as the determination signal. This brings about an effect of reducing power consumption of the imaging device.

Furthermore, in the second aspect, the pre-stage circuit and the sample hold circuit may be arranged in each of a plurality of pixels, and the determination circuit may determine a pixel in a region of a focused subject among the plurality of pixels as a pixel whose held value is not updated. This brings about an effect that a composite image focused on a plurality of subjects is captured.

### BRIEF DESCRIPTION OF DRAWINGS

FIG. 1 is a block diagram illustrating a configuration example of an imaging device according to a first embodiment of the present technology.

FIG. 2 is a block diagram illustrating a configuration example of a solid-state imaging element according to the first embodiment of the present technology.

FIG. 3 is a circuit diagram illustrating a configuration example of a pixel according to the first embodiment of the present technology.

FIG. 4 is a diagram illustrating an example of an operation of a latch circuit according to the first embodiment of the present technology.

FIG. 5 is a block diagram illustrating a configuration example of the load MOS circuit block and the column signal processing circuit according to the first embodiment of the present technology.

FIG. 6 is a timing chart illustrating an example of an operation of the imaging device according to the first embodiment of the present technology.

FIG. 7 is a timing chart illustrating an example of a first global shutter operation according to the first embodiment of the present technology.

FIG. 8 is a timing chart illustrating an example of an operation at the time of determination according to the first embodiment of the present technology.

FIG. 9 is a timing chart illustrating an example of a second global shutter operation according to the first embodiment of the present technology.

FIG. 10 is a timing chart illustrating an example of a read operation according to the first embodiment of the present technology.

FIG. 11 is a timing chart illustrating an example of an operation of an imaging device according to a comparative example.

FIG. 12 is a diagram illustrating an example of image data before composition according to a comparative example.

FIG. 13 is a diagram illustrating an example of image data after composition according to the first embodiment and the comparative example of the present technology.

FIG. 14 is a flowchart illustrating an example of an operation of the solid-state imaging element according to the first embodiment of the present technology.

FIG. 15 is a diagram illustrating a configuration example of a pixel array section according to a first modification of the first embodiment of the present technology.

FIG. 16 is a circuit diagram illustrating a configuration example of a pixel according to the first modification example of the first embodiment of the present technology.

FIG. 17 is a diagram illustrating an example of image data before composition according to the first modification of the first embodiment of the present technology.

FIG. 18 is a diagram illustrating an example of image data after composition according to the first modification of the first embodiment of the present technology.

FIG. 19 is a circuit diagram illustrating a configuration example of a pixel according to a second modification example of the first embodiment of the present technology.

FIG. 20 is a timing chart illustrating an example of a read operation according to the second modification example of the first embodiment of the present technology.

FIG. 21 is a block diagram illustrating a configuration example of a load MOS circuit block and a column signal processing circuit according to a second embodiment of the present technology.

FIG. 22 is a circuit diagram illustrating a configuration example of a pixel according to the second embodiment of the present technology.

FIG. 23 is a timing chart illustrating an example of an operation of an imaging device according to the second embodiment of the present technology.

FIG. 24 is a circuit diagram illustrating a configuration example of a pixel according to a modification of the second embodiment of the present technology.

FIG. 25 is a circuit diagram illustrating a configuration example of a pixel according to a third embodiment of the present technology.

FIG. 26 is a block diagram illustrating a configuration example of a DSP circuit according to the third embodiment of the present technology.

FIG. 27 is a timing chart illustrating an example of imaging operation until third exposure of an imaging device according to the third embodiment of the present technology.

FIG. 28 is a timing chart illustrating an example of imaging operation at the time of fourth exposure of the imaging device according to the third embodiment of the present technology.

FIG. 29 is a diagram illustrating an example of image data before composition according to the third embodiment of the present technology.

FIG. 30 is a diagram illustrating an example of image data after composition according to the third embodiment of the present technology.

FIG. 31 is a diagram illustrating an example of a laminated structure of a solid-state imaging element according to a fourth embodiment of the present technology.

FIG. 32 is a circuit diagram illustrating a configuration example of a pixel according to the fourth embodiment of the present technology.

FIG. 33 is a circuit diagram illustrating another example of the pixel according to the fourth embodiment of the present technology.

FIG. 34 is a diagram illustrating an example of a laminated structure of a solid-state imaging element according to a modification of the fourth embodiment of the present technology.

FIG. 35 is a circuit diagram illustrating a configuration example of a pixel according to a fifth embodiment of the present technology.

FIG. 36 is a timing chart illustrating an example of a global shutter operation according to the fifth embodiment of the present technology.

FIG. 37 is a timing chart illustrating an example of a read operation according to the fifth embodiment of the present technology.

FIG. 38 is a circuit diagram illustrating a configuration example of a pixel according to a sixth embodiment of the present technology.

FIG. 39 is a timing chart illustrating an example of a global shutter operation according to the sixth embodiment of the present technology.

FIG. 40 is a circuit diagram illustrating a configuration example of a pixel according to a seventh embodiment of the present technology.

FIG. 41 is a diagram for explaining reset feedthrough according to the seventh embodiment of the present technology.

FIG. 42 is a diagram for explaining variations in level caused by reset feedthrough according to the seventh embodiment of the present technology.

FIG. 43 is a timing chart illustrating an example of voltage control according to the seventh embodiment of the present technology.

FIG. 44 is a timing chart illustrating an example of a global shutter operation for odd frames according to an eighth embodiment of the present technology.

FIG. 45 is a timing chart illustrating an example of a read operation for odd frames according to the eighth embodiment of the present technology.

FIG. 46 is a timing chart illustrating an example of a global shutter operation for even frames according to the eighth embodiment of the present technology.

FIG. 47 is a timing chart illustrating an example of a read operation for even frames according to the eighth embodiment of the present technology.

FIG. 48 is a circuit diagram illustrating a configuration example of a column signal processing circuit according to a ninth embodiment of the present technology.

FIG. 49 is a timing chart illustrating an example of a global shutter operation according to the ninth embodiment of the present technology.

FIG. 50 is a timing chart illustrating an example of a read operation according to the ninth embodiment of the present technology.

FIG. 51 is a timing chart illustrating an example of a rolling shutter operation according to a 10th embodiment of the present technology.

FIG. 52 is a block diagram illustrating a configuration example of a solid-state imaging element according to an 11th embodiment of the present technology.

FIG. 53 is a circuit diagram illustrating a configuration example of a dummy pixel, a regulator, and a switching section according to the 11th embodiment of the present technology.

FIG. 54 is a timing chart illustrating an example of how the dummy pixel and the regulator operate according to the 11th embodiment of the present technology.

FIG. 55 is a circuit diagram illustrating a configuration example of an effective pixel according to the 11th embodiment of the present technology.

FIG. 56 is a timing chart illustrating an example of a global shutter operation according to the 11th embodiment of the present technology.

FIG. 57 is a timing chart illustrating an example of a read operation according to the 11th embodiment of the present technology.

FIG. 58 is a diagram for explaining effects according to the 11th embodiment of the present technology.

FIG. 59 is a block diagram illustrating a schematic configuration example of a vehicle control system.

FIG. 60 is an explanatory diagram illustrating an example of an installation position of an imaging section.

### MODE FOR CARRYING OUT THE INVENTION

Hereinafter, modes for carrying out the present technology (hereinafter referred to as embodiments) will be described. The description will be given in the following order.
1. First Embodiment (Example of Determining Whether or Not to Update Held Value)
2. Second Embodiment (Example of Determining Whether or Not to Update Held Value on Basis of Digital Signal)
3. Third Embodiment (Example of Determining Whether or Not to Update Held Value Depending on Whether or Not Focusing Is Performed)
4. Fourth Embodiment (Example in Which Pixels for Determining Whether or Not to Update Held Value Are Dispersedly Arranged on Plurality of Chips)
5. Fifth Embodiment (Example of Determining Whether or Not to Update Held Value and Reducing Noise)
6. Sixth Embodiment (Example of Adding Discharge Transistor and Determining Whether or Not to Update Held Value)
7. Seventh Embodiment (Example of Causing First and Second Capacitor Elements to Hold Pixel Signals and Determining Whether or Not to Update Held Values)
8. Eighth Embodiment (Example of Determining Whether or Not to Update Held Value and Reversing Levels to Be Held in Each Frame)
9. Ninth Embodiment (Example of Determining Whether or Not to Update Held Value and Suppressing Black Spot Phenomenon)
10. 10th Embodiment (Example of Performing Rolling Shutter Operation at Time of Test and Determining Whether or Not to Update Held Value)
11. 11th Embodiment (Example of Turning off Pre-stage Source Follower at Time of Reading and Determining Whether or Not to Update Held Value)
12. Application Example to Mobile Body

### 1. First Embodiment

### [Configuration Example of Imaging Device]

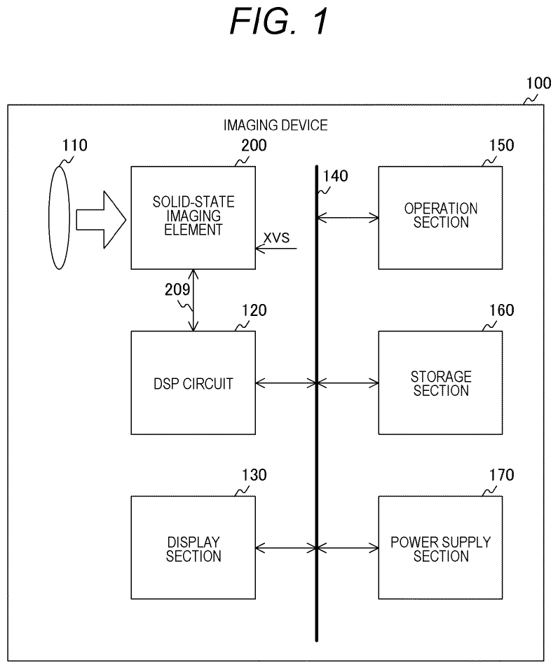

FIG. 1 is a block diagram illustrating a configuration example of an imaging device 100 according to a first embodiment of the present technology. The imaging device 100 is a device for imaging image data, and is provided with an optical section 110, a solid-state imaging element 200, and a digital signal processing (DSP) circuit 120. The imaging device 100 further includes a display section 130, a bus 140, an operation section 150, a storage section 160, and a power supply section 170. As the imaging device 100, for example, in addition to a digital camera such as a digital still camera, a smartphone or a personal computer having an imaging function, an in-vehicle camera, a monitoring camera, or the like is assumed.

The optical section 110 condenses light from a subject and guides the light to the solid-state imaging element 200. The solid-state imaging element 200 generates image data by photoelectric conversion in synchronization with the vertical synchronization signal XVS. Here, the vertical synchronization signal XVS is a periodic signal of a predetermined frequency indicating imaging timing. The solid-state imaging element 200 supplies the generated image data to the DSP circuit 120 via a signal line 209.

The DSP circuit 120 executes predetermined signal processing on the image data from the solid-state imaging element 200. The DSP circuit 120 outputs the processed image data to the display section 130 and the storage section 160 via the bus 140.

The display section 130 displays the image data. As the display section 130, for example, a liquid crystal panel or an organic electro luminescence (EL) panel is assumed. The operation section 150 generates an operation signal according to a user's operation.

The bus 140 is a common path for the optical section 110, the solid-state imaging element 200, the DSP circuit 120, the display section 130, the operation section 150, the storage section 160, and the power supply section 170 to exchange data with each other.

The storage section 160 stores various types of data such as the image data. The power supply section 170 supplies power to the solid-state imaging element 200, the DSP circuit 120, the display section 130 and the like.

### [Configuration Example of Solid-State Imaging Element]

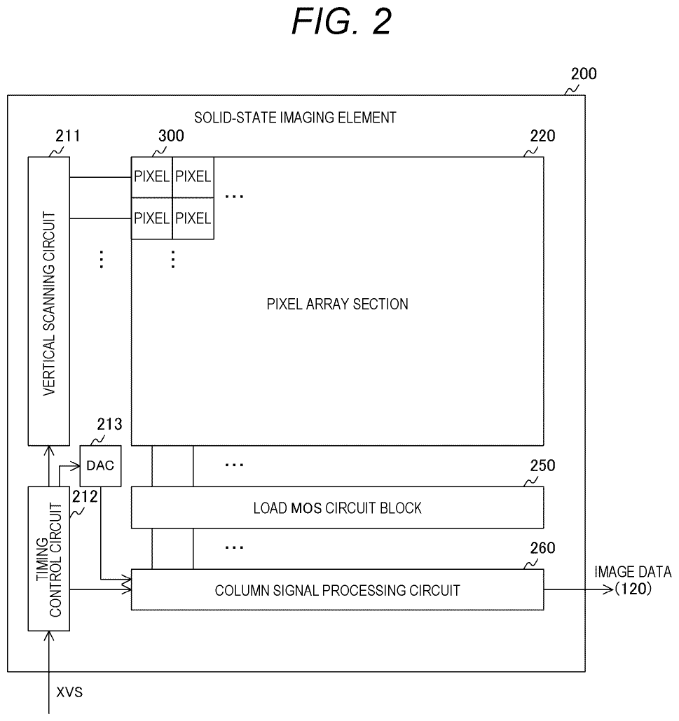

FIG. 2 is a block diagram illustrating a configuration example of the solid-state imaging element 200 according to the first embodiment of the present technology. The solid-state imaging element 200 includes a vertical scanning circuit 211, a pixel array section 220, a timing control circuit 212, a digital to analog converter (DAC) 213, a load MOS circuit block 250, and a column signal processing circuit 260. In the pixel array section 220, a plurality of pixels 300 is arranged in a two-dimensional grid pattern. Furthermore, each circuit in the solid-state imaging element 200 is provided in, for example, a single semiconductor chip.

Hereinafter, a set of pixels 300 arranged in a horizontal direction is referred to as “row”, and a set of pixels 300 arranged in a direction perpendicular to the row is referred to as “column”.

The timing control circuit 212 controls the operation timing of each of the vertical scanning circuit 211, the DAC 213, and the column signal processing circuit 260 in synchronization with the vertical synchronization signal XVS.

The DAC 213 generates a sawtooth wave-like ramp signal by digital to analog (DA) conversion. The DAC 213 supplies the generated ramp signal to the column signal processing circuit 260.

The vertical scanning circuit 211 sequentially selects and drives rows to output analog pixel signals. The pixel 300 photoelectrically converts incident light to generate the analog pixel signal. This pixel 300 supplies the pixel signal to the column signal processing circuit 260 via the load MOS circuit block 250.

In the load MOS circuit block 250, a MOS transistor that supplies a constant current is provided for each column.

The column signal processing circuit 260 performs signal processing such as AD conversion processing or CDS processing on the pixel signal for each column. The column signal processing circuit 260 supplies image data including the processed signal to the DSP circuit 120.

### [Configuration Example of Pixel]

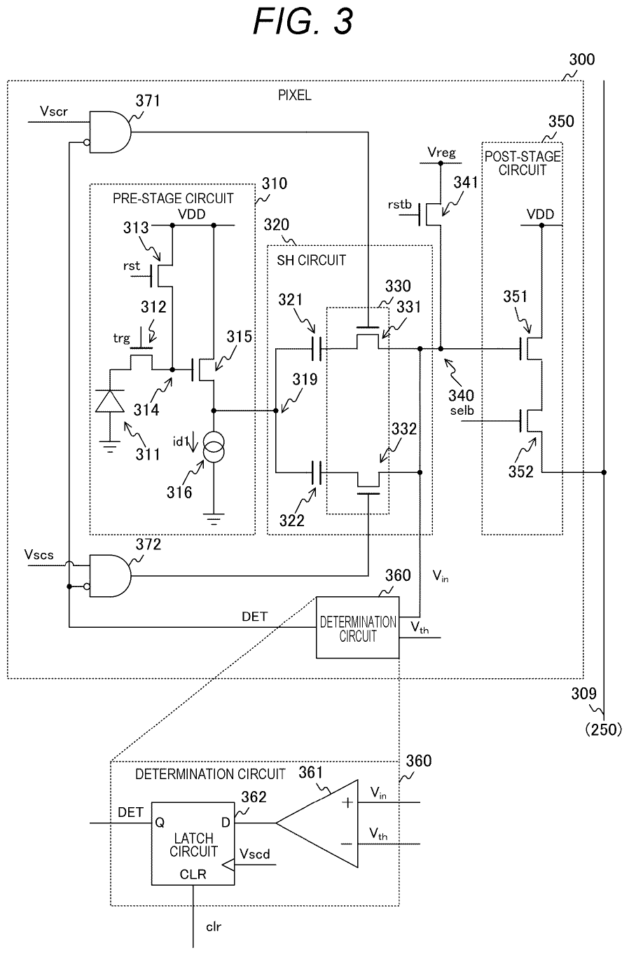

FIG. 3 is a circuit diagram illustrating a configuration example of the pixel 300 according to the first embodiment of the present technology. The pixel 300 includes a pre-stage circuit 310, a sample hold circuit 320, a post-stage reset transistor 341, and a post-stage circuit 350. The pixel 300 further includes a determination circuit 360 and AND (logical product) gates 371 and 372.

The pre-stage circuit 310 generates an analog pixel signal. The pre-stage circuit 310 includes a photoelectric conversion element 311, a transfer transistor 312, a floating diffusion (FD) reset transistor 313, an FD 314, a pre-stage amplification transistor 315, and a current source transistor 316.

The photoelectric conversion element 311 generates charges by the photoelectric conversion. The transfer transistor 312 transfers the charges from the photoelectric conversion element 311 to the FD 314 in accordance with a transfer signal trg from the vertical scanning circuit 211.

The FD reset transistor 313 extracts the charges from the FD 314 to initialize the FD 314 in accordance with an FD reset signal rst from the vertical scanning circuit 211. The FD 314 accumulates charges, and generates a voltage corresponding to a charge amount. The pre-stage amplification transistor 315 amplifies a level of a voltage of the FD 314, and outputs the amplified voltage to a pre-stage node 319.

Furthermore, the FD reset transistor 313 and the pre-stage amplification transistor 315 have their respective sources connected to a power supply voltage VDD. The current source transistor 316 is connected to a drain of the pre-stage amplification transistor 315. The current source transistor 316 supplies a current id1 under the control of the vertical scanning circuit 211.

The sample hold circuit 320 samples and holds the level of the pixel signal. The sample hold circuit 320 includes capacitor elements 321 and 322 and a selection circuit 330. The capacitor elements 321 and 322 have their respective one ends commonly connected to the pre-stage node 319 and have their respective other ends connected to the selection circuit 330.

The selection circuit 330 includes a selection transistor 331 and a selection transistor 332. The selection transistor 331 opens and closes a path between the capacitor element 321 and the post-stage node 340 according to an output signal of the AND gate 371. The selection transistor 332 opens and closes a path between the capacitor element 322 and the post-stage node 340 according to an output signal of the AND gate 372.

The post-stage reset transistor 341 initializes a level of the post-stage node 340 to a predetermined potential Vreg in accordance with a post-stage reset signal rstb from the vertical scanning circuit 211. A potential different from the power supply potential VDD (for example, a potential lower than VDD) is set as the potential Vreg.

The post-stage circuit 350 reads and amplifies the pixel signal from the sample hold circuit 320. This post-stage circuit 350 includes a post-stage amplification transistor 351, and a post-stage selection transistor 352. The post-stage amplification transistor 351 amplifies the level of the post-stage node 340. The post-stage selection transistor 352 outputs a signal at a level amplified by the post-stage amplification transistor 351 to the vertical signal line 309 in accordance with a post-stage selection signal selb from the vertical scanning circuit 211.

Note that, for example, n-channel metal oxide semiconductor (nMOS) transistors are used as various transistors (transfer transistor 312 and the like) in the pixel 300.

The determination circuit 360 determines whether or not to update the held value of the sample hold circuit 320, and supplies a determination signal DET indicating a determination result to the AND gates 371 and 372. The determination circuit 360 includes a comparator 361 and a latch circuit 362.

The comparator 361 compares the level of the pixel signal with a predetermined threshold value. The non-inverting input terminal (+) of the comparator 361 is connected to the post-stage node 340, and the voltage of the node is input as the input voltage Vin. In addition, a constant direct current (DC) voltage Vth indicating a threshold value is input to the inverting input terminal (−) of the comparator 361. The comparator 361 compares the input voltage Vin, which is the level of the pixel signal, with the DC voltage Vth, and outputs a comparison result to the latch circuit 362. In a case where the input voltage Vin is higher than the DC voltage Vth (that is, the level of the pixel signal is higher than the threshold value), a high-level comparison result is output as the determination signal DET. The high-level determination signal DET indicates that it is determined not to update the held value. On the other hand, in a case where the input voltage Vin is equal to or lower than the DC voltage Vth, the low-level comparison result is output as the determination signal DET. The low-level determination signal DET indicates that it is determined to update the held value.

The latch circuit 362 holds the determination signal DET from the comparator 361. The input terminal D of the latch circuit 362 is connected to an output terminal of the comparator 361. The output terminal of the latch circuit 362 is connected to the AND gates 371 and 372. The scan signal Vscs from the vertical scanning circuit 211 is input to the clock terminal of the latch circuit 362. Furthermore, the clear signal clr from the vertical scanning circuit 211 is input to the clear terminal CLR of the latch circuit 362.

Here, the scan signal Vscs is a pulse signal indicating a sample timing of a signal level of the sample hold circuit 320 and a read timing thereof. Furthermore, the clear signal clr is a pulse signal that instructs initialization of the held value of the latch circuit 362, and is supplied at the read timing.

The AND gate 371 outputs a logical product (AND) of the scan signal Vscr and an inverted value of the determination signal DET to the selection transistor 331. Here, the scan signal Vscr is a pulse signal indicating a sample timing of a reset level of the sample hold circuit 320 and a read timing thereof.

The AND gate 372 outputs a logical product (AND) of the scan signal Vscs and an inverted value of the determination signal DET to the selection transistor 332.

The vertical scanning circuit 211 supplies the high-level FD reset signal rst and the high-level transfer signal trg to all the pixels at the start of exposure. Therefore, the photoelectric conversion element 311 is initialized. Hereinafter, this control is referred to as “PD reset”.

Then, the vertical scanning circuit 211 supplies the high-level FD reset signal rst over the pulse period while setting the post-stage reset signal rstb and the scan signal Vscr to the high level for all the pixels immediately before the end of the exposure. Therefore, the FD 314 is initialized, and a level corresponding to the level of the FD 314 at that time is held in the capacitor element 321. This control is hereinafter referred to as “FD reset”.

The level of the FD 314 at the time of the FD reset and the level (holding level of capacitor element 321 or level of vertical signal line 309) of the pixel signal corresponding to the level are hereinafter collectively referred to as “P-phase” or “reset level”.

At the end of the exposure, the vertical scanning circuit 211 supplies the high-level transfer signal trg over the pulse period while setting the post-stage reset signal rstb and the scan signal Vscs to the high level for all the pixels. Therefore, signal charges corresponding to an exposure amount are transferred to the FD 314, and a level corresponding to the level of the FD 314 at that time is held in the capacitor element 322.

The level of the FD 314 at the time of signal charge transfer and the level (holding level of capacitor element 322 or level of vertical signal line 309) of the pixel signal corresponding to the level are hereinafter collectively referred to as “D-phase” or “signal level”.

The exposure control of simultaneously starting and ending the exposure for all the pixels in this manner is called a global shutter method. Under this exposure control, the pre-stage circuits 310 of all the pixels sequentially generate the reset level and the signal level. The reset level of the pixel signal is held in the capacitor element 321, and the signal level of the pixel signal is held in the capacitor element 322.

Here, the solid-state imaging element 200 can perform comparative bright combination as necessary. Whether or not to perform the comparative bright combination is manually set, for example, by a user operation. Alternatively, the DSP circuit 120 detects the imaging scene, and automatically sets whether or not to perform the comparative bright combination on the basis of the detection result. In the case of automatic setting, for example, the comparative bright combination is executed when a scene of a night scene is detected.

Hereinafter, control in the case of performing comparative bright combination will be described. In a case where the comparative bright combination is performed, the number of sheets to be combined is designated by the user or the DSP circuit 120. The number of sheets to be combined is K (K is an integer of 2 or more).

In a case where the number of combined sheets is K, the vertical scanning circuit 211 performs exposure by the above-described global shutter method over K times. In addition, the determination circuit 360 determines whether or not to update the held value immediately after each exposure up to (K−1)^{th}, and supplies the determination signal DET. That is, K−1 times of determination are performed.

The sample hold circuit 320 holds the level of the pixel signal as a held value at the end of the first exposure, and updates the held value according to the level of the second and subsequent pixel signals in accordance with the determination signal DET at the end of each of the second and subsequent exposures. However, it is assumed that the pixel signal is not output to the column signal processing circuit 260 until the K-th exposure is completed. After completion of the K-th exposure, the vertical scanning circuit 211 sequentially drives the rows and outputs the pixel signals to the column signal processing circuit 260.

K, which is the number of combined sheets, is set to, for example, “2”. In this case, the pre-stage circuit 310 generates a pixel signal at each of the end of the first exposure and the end of the second exposure. The sample hold circuit 320 holds the level (reset level and signal level) of the first pixel signal as a held value. The determination circuit 360 compares the signal level (input voltage Vin) of the first pixel signal with the threshold value (DC voltage Vth), and outputs a signal indicating the comparison result as the determination signal DET.

In the determination circuit 360, the comparator 361 supplies the comparison result as the determination signal DET to the latch circuit 362, and the latch circuit 362 fetches and holds the determination signal DET at the sample timing indicated by the scan signal Vscs.

The AND gates 371 and 372 supply the scan signals Vscr and Vscs to the sample hold circuit 320 on the basis of the determination signal DET. In a case where the determination signal DET is at the high level (that is, the signal level is higher than the threshold value), the AND gates 371 and 372 do not output the scan signals Vscr and Vscs. The state of the AND gate 371 and the like is set to the locked state. In the locked state, since the scan signal is not supplied, the sample hold circuit 320 does not update the held value.

On the other hand, in a case where the determination signal DET is at a low level (that is, the signal level is equal to or less than the threshold value), the AND gates 371 and 372 output the scan signals Vscr and Vscs. That is, the locked state is released. In a case where the locked state is released, the sample hold circuit 320 updates the held value at the sample timing indicated by the scan signals.

Note that the AND gates 371 and 372 are an example of a logic gate described in the claims.

After the K-th exposure, the vertical scanning circuit 211 sequentially selects the row, and sequentially outputs the reset level and the signal level of the row while setting the clear signal clr of the selected row to the high level. By this control, the determination signal DET is initialized to the low level at the read timing, and the locked states of the AND gates 371 and 372 are released.

When outputting the reset level, the vertical scanning circuit 211 supplies the high-level scan signal Vscr over the pulse period while setting the FD reset signal rst and the post-stage selection signal selb of the selected row to the high level. Therefore, the capacitor element 321 is connected to the post-stage node 340, and the reset level is read.

After reading the reset level, the vertical scanning circuit 211 supplies the high-level post-stage reset signal rstb over the pulse period while keeping the FD reset signal rst and the post-stage selection signal selb of the selected row at the high level. Therefore, the level of the post-stage node 340 is initialized. At this time, both the selection transistor 331 and the selection transistor 332 are in an open state, and the capacitor elements 321 and 322 are disconnected from the post-stage node 340.

After the initialization of the post-stage node 340, the vertical scanning circuit 211 supplies the high-level scan signal Vscs over the pulse period while keeping the FD reset signal rst and the post-stage selection signal selb of the selected row at the high level. Therefore, the capacitor element 322 is connected to the post-stage node 340, and the signal level is read.

As described above, since the determination circuit 360 determines whether or not to update the held value on the basis of whether or not the signal level is higher than the threshold value for each pixel, the held value is updated at the end of exposure for the pixel having the signal level equal to or lower than the threshold value. On the other hand, for a pixel whose signal level is higher than the threshold value, the held value is not updated at the end of exposure. By this control, the image output after the K-th exposure is a composite image obtained by comparative bright combination of K images.

Since no signal is output to the column signal processing circuit 260 at the subsequent stage until the composite image is output, the processing amount of AD conversion and the like in the column signal processing circuit 260 is reduced. In addition, it is not necessary to hold image data to be combined in the frame memory, and the number of accesses to the frame memory is reduced. Therefore, the power consumption can be reduced by the reduction in the number of accesses and the processing amount.

Note that, in a case where the comparative bright combination is not performed, the solid-state imaging element 200 does not perform determination, and performs exposure and reading each time image data is captured.

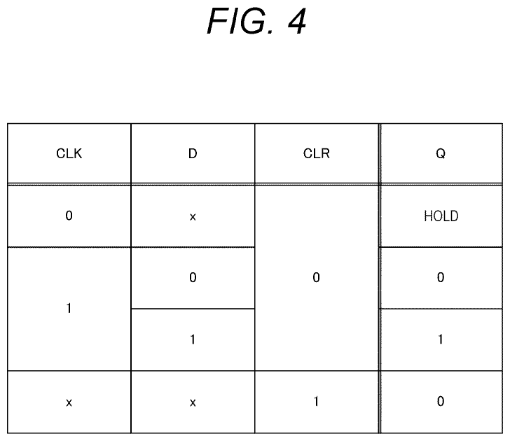

FIG. 4 is a diagram illustrating an example of an operation of the latch circuit 362 according to the first embodiment of the present technology. The latch circuit 362 includes a clock terminal CLK, an input terminal D, a clear terminal CLR, and an output terminal Q.

In a case where the value of the clear terminal CLR is the logical value “0” and the value of the clock terminal CLK is the logical value “0”, the latch circuit 362 holds 1-bit information regardless of the value of the input terminal D. That is, the latch circuit 362 enters a latch state (or a hold state). In a case where the value of the clear terminal CLR is the logical value “0” and the value of the clock terminal CLK is the logical value “1”, the latch circuit 362 outputs the value of the input terminal D as it is from the output terminal Q. That is, the latch circuit 362 enters the through state.

In a case where the value of the clear terminal CLR is the logical value “1”, the latch circuit 362 outputs the logical value “0” from the output terminal Q regardless of the values of the clock terminal CLK and the input terminal D. That is, the held value of the latch circuit 362 is initialized.

[Configuration Example of Column Signal Processing Circuit]

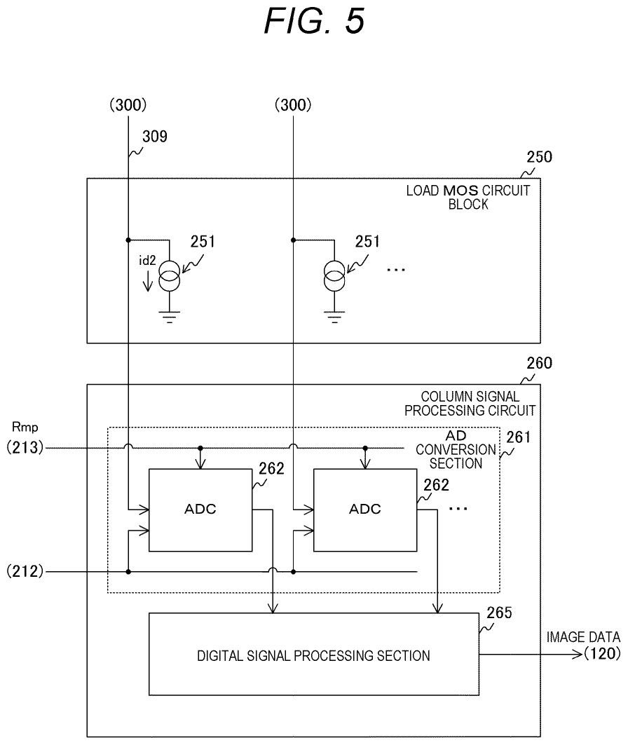

FIG. 5 is a block diagram illustrating a configuration example of the load MOS circuit block 250 and the column signal processing circuit 260 according to the first embodiment of the present technology.

In the load MOS circuit block 250, the vertical signal line 309 is wired for each column. When the number of columns is M (M is an integer), M vertical signal lines 309 are wired. In addition, a load MOS transistor 251 that supplies a constant current id2 is connected to each of the vertical signal lines 309.

In the column signal processing circuit 260, an AD conversion section 261 and a digital signal processing section 265 are arranged. In the AD conversion section 261, the ADC 262 is arranged for each column. When the number of columns is M, M ADCs 262 are arranged.

The ADC 262 converts an analog pixel signal from the corresponding column into a digital signal using a ramp signal Rmp from the DAC 213. The ADC 262 supplies the digital signal to the digital signal processing section 265. For example, a single-slope ADC including a comparator and a counter is arranged as the ADC 262.

The digital signal processing section 265 performs predetermined signal processing such as CDS processing on the digital signal for each column. The digital signal processing section 265 supplies image data in which the processed digital signals are arranged to the DSP circuit 120.

### [Operation Example of Imaging Device]

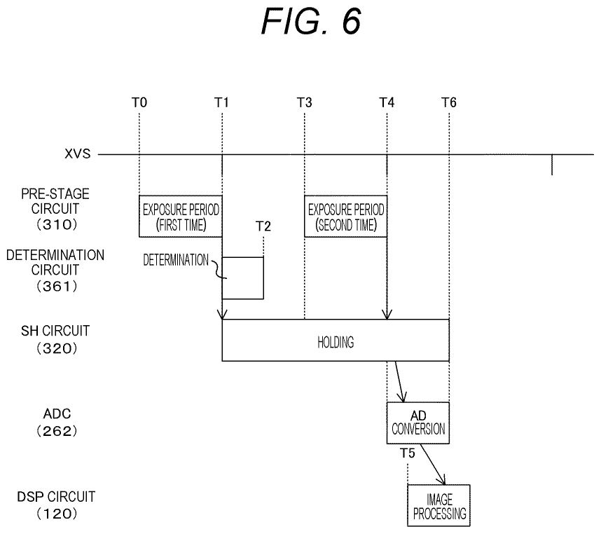

FIG. 6 is a timing chart illustrating an example of the operation of the imaging device 100 according to the first embodiment of the present technology. It is assumed that the number of sheets to be combined is two. The pre-stage circuit 310 of all the pixels generates a pixel signal at a level corresponding to the exposure amount within the first exposure period from timing T0 to T1. At the end of the exposure, the sample hold circuits 320 of all the pixels sample and hold the levels (reset level and signal level) of the first pixel signal.

The determination circuits 360 of all the pixels compare the signal level of the first pixel signal with the threshold value within the period from timing T1 to T2, and determine whether or not the signal level is higher than the threshold value.

Then, the pre-stage circuit 310 of all the pixels generates a pixel signal at a level corresponding to the exposure amount within the second exposure period from timing T3 to T4. At the end of the exposure, the sample hold circuit 320 of each pixel updates the held value with the second pixel signal in a case where it is determined that the signal level is equal to or less than the threshold value. On the other hand, in a case where it is determined that the signal level is higher than the threshold value, the held value is not updated.

The rows are sequentially selected within the period from timing T4 to timing T6, and the ADC 262 performs AD conversion on the pixel signals of the selected rows. After timing T5, the DSP circuit 120 performs various image processing such as demosaic processing and white balance correction on the image data generated by the AD conversion.

Note that, in a case where the number of sheets to be combined is three or more, the determination is performed after the exposure ends until the (K−1)th exposure, and the AD conversion is started after the K-th exposure ends.

Furthermore, in a case where the imaging device 100 performs imaging without performing comparative bright combination, the imaging device 100 does not perform determination, and executes AD conversion (in other words, read) for each exposure.

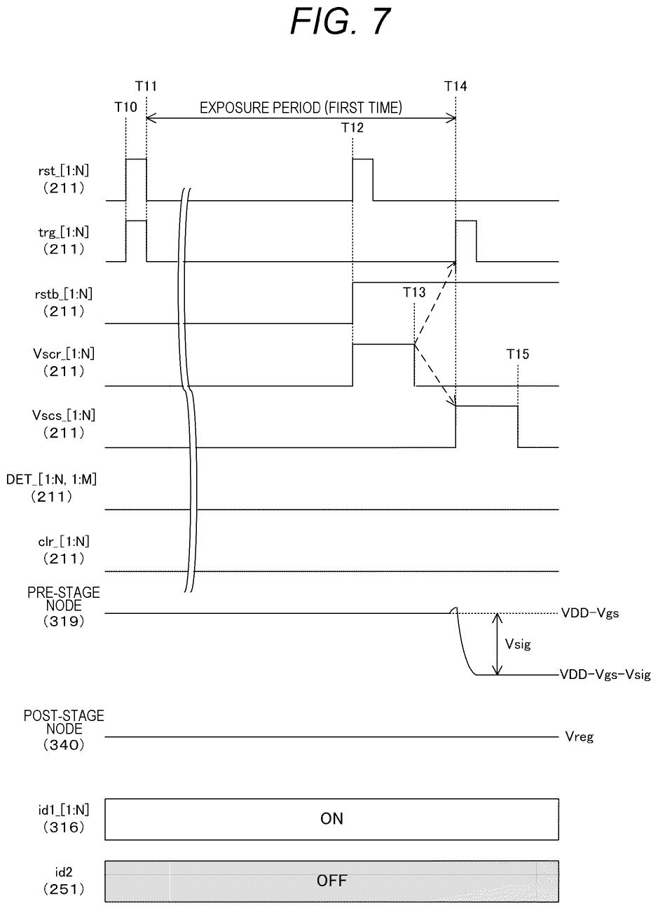

FIG. 7 is a timing chart illustrating an example of a first global shutter operation according to the first embodiment of the present technology. The drawing illustrates details of the operation in the period from T0 to T1 in FIG. 6.

In FIG. 7, the vertical scanning circuit 211 supplies the high-level FD reset signal rst and the transfer signal trg to all the rows (in other words, all pixels) from timing T10 immediately before the exposure start to timing T11 after the pulse period has elapsed. Therefore, all the pixels are PD reset, and the exposure simultaneously starts in all the rows.

Here, rst_[n] and trg_[n] in the drawing indicate signals to pixels in an n-th row among N rows. N is an integer indicating the total number of rows, and n is an integer from 1 to N.

Then, at timing T12 immediately before the end of the exposure period, the vertical scanning circuit 211 supplies the high-level FD reset signal rst over the pulse period while setting the post-stage reset signal rstb and the scan signal Vscr to the high level in all the pixels. As a result, all the pixels are FD reset, and the reset level is sampled and held. Here, rstb_[n] and Vscr_[n] in the drawing indicate signals to pixels in the n-th row.

At timing T13 after timing T12, the vertical scanning circuit 211 returns the scan signal Vscr to the low level.

At the exposure end timing T14, the vertical scanning circuit 211 supplies the high-level transfer signal trg over the pulse period while setting the post-stage reset signal rstb and the scan signal Vscs to the high level in all the pixels. As a result, the signal level is sampled and held. In addition, the level of the pre-stage node 319 decreases from the reset level (VDD-Vgs) to the signal level (VDD-Vgs-Vsig). Here, VDD indicates a power supply voltage, and Vsig indicates a net signal level obtained as a result of the CDS processing. Vgs indicates a gate-source voltage of the pre-stage amplification transistor 315. In addition, Vscs_[n] in the drawing indicates signals to pixels in the n-th row.

At timing T15 after timing T14, the vertical scanning circuit 211 returns the scan signal Vscs to the low level.

Furthermore, the vertical scanning circuit 211 keeps the clear signals clr of all the pixels at the low level. In addition, since the level of the post-stage node 340 is equal to or lower than the threshold value, the determination signals DET of all the pixels are at a low level. Therefore, the locked states of the AND gates 371 and 372 of all the pixels are released. Here, clr_[n] in the drawing indicates a signal to the n-th row. DET_[n, m] indicates a determination signal of a pixel of an n-th row and an m-th (m is an integer of 1 to M) column.

Furthermore, the vertical scanning circuit 211 controls the current source transistors 316 of all the rows (all the pixels) to supply the current id1. Here, id1_[n] in the drawing indicates a current of pixels in the n-th row. The larger the current id, the larger IR drop becomes, so that it is required that the current id1 be on the order of several nanoamperes (nA) to several tens of nanoamperes (nA). On the other hand, the load MOS transistors 251 of all the columns are in the off state, and the current id2 is not supplied to the vertical signal line 309.

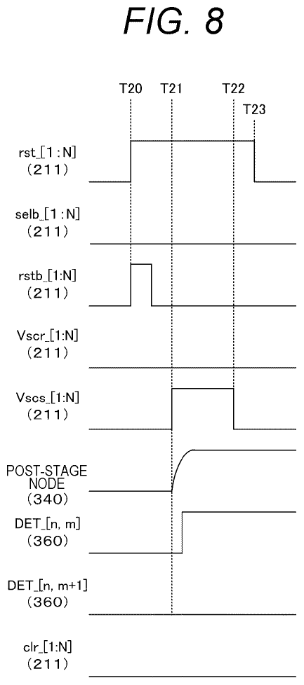

FIG. 8 is a timing chart illustrating an example of an operation at the time of determination according to the first embodiment of the present technology. The drawing illustrates details of the operation in the period from T1 to T2 in FIG. 6.

In the determination period from timing T20 to timing T23 in FIG. 8, the vertical scanning circuit 211 sets the FD reset signals rst of all rows to the high level. The post-stage selection signals selb of all the rows remain at the low level, and the pixel signals are not output to the column signal processing circuits 260. Here, selb_[n] in the drawing indicates signals to pixels in the n-th row.

From timing T20 to the pulse period, the vertical scanning circuit 211 supplies the high-level post-stage reset signal rstb to all the rows.

Then, the vertical scanning circuit 211 supplies the high-level scan signal Vscs to the n-th row over a period from timing T21 to timing T22. The potential of the post-stage node 340 becomes the signal level. For each pixel, the determination circuit 360 compares the signal level with a threshold value.

For example, it is assumed that the signal level is higher than the threshold value in the pixel of the n-th row and the m-th column, and the signal level is equal to or lower than the threshold value in the pixel of the n-th row and the (m+1)th column. In this case, the determination signal DET_[n, m] goes to a high level, and the determination signal DET_[n, m+1] remains at a low level.

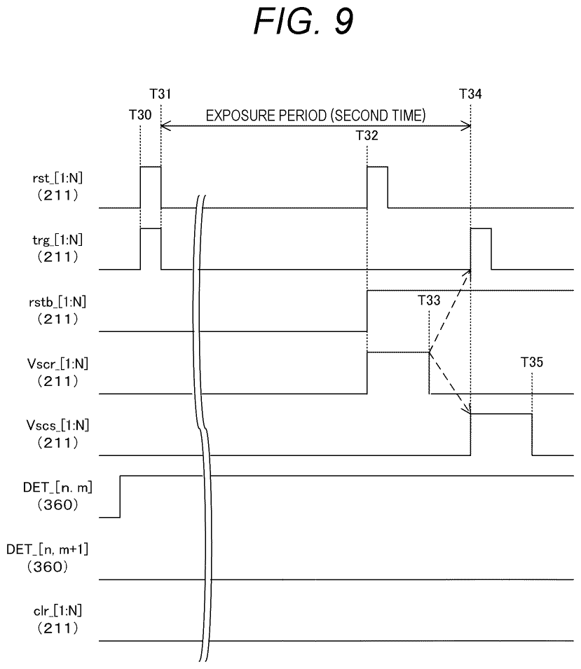

FIG. 9 is a timing chart illustrating an example of a second global shutter operation according to the first embodiment of the present technology. The drawing illustrates details of the operation in the period from T3 to T4 in FIG. 6.

In FIG. 9, during a period of timings T30 to T35, the vertical scanning circuit 211 performs control similar to the first time. On the other hand, for each pixel, when the determination signal DET is at a low level, the sample hold circuit 320 updates the held value according to the level of the second pixel signal. It is assumed that the determination signal DET_[n, m] is at a high level and the determination signal DET_[n, m+1] is at a low level. In this case, the sample hold circuit 320 in the n-th row and the m-th column does not update the held value, and the sample hold circuit 320 in the n-th row and the (m+1)th column updates the held value.

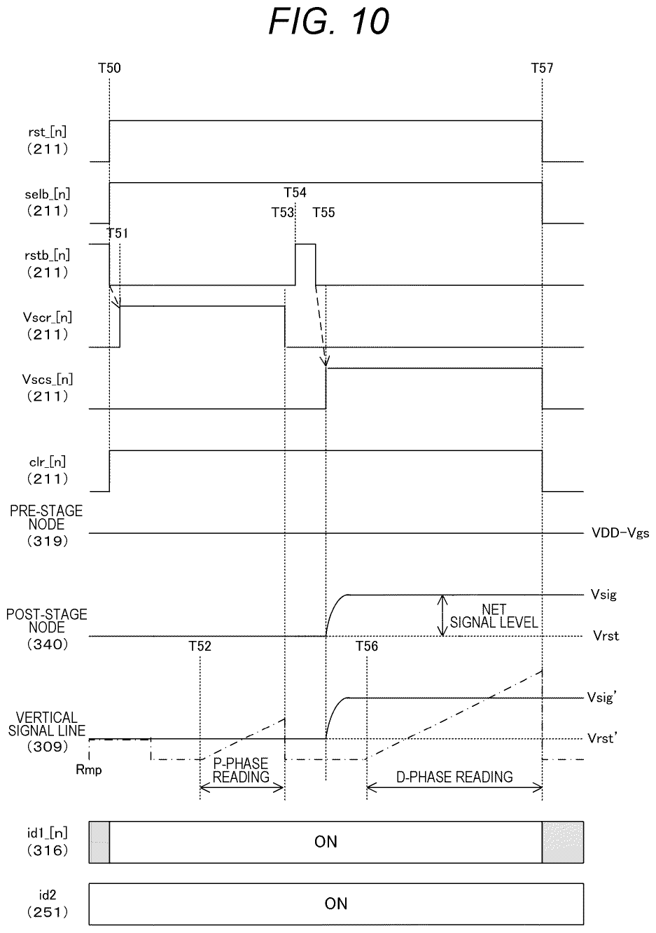

FIG. 10 is a timing chart illustrating an example of a read operation according to the first embodiment of the present technology. The drawing illustrates details of operations from T4 to T6 in FIG. 6.

In the read period of the n-th row from timing T50 to timing T57 in FIG. 10, the vertical scanning circuit 211 sets the FD reset signal rst, the post-stage selection signal selb, and the clear signal clr of the n-th row to the high level. Furthermore, over the read period, the post-stage reset signal rstb of all the rows is controlled to the low level.

The vertical scanning circuit 211 supplies the high-level scan signal Vscr to the n-th row over a period from timing T51 immediately after timing T50 to immediately before timing T53. The potential of the post-stage node 340 becomes the reset level Vrst.

The DAC 213 gradually increases the ramp signal Rmp over a period from timing T52 after timing T51 to timing T53. The ADC 261 compares the ramp signal Rmp with a level Vrst′ of the vertical signal line 309, and counts a count value over a period until the comparison result is inverted. Therefore, the P-phase level (reset level) is read.

The vertical scanning circuit 211 supplies the high-level post-stage reset signal rstb to the n-th row from timing T54 immediately after timing T53 to the pulse period. Therefore, in a case where a parasitic capacitance exists in the post-stage node 340, the history of the previous signal held in the parasitic capacitance can be erased.

The vertical scanning circuit 211 supplies the high-level scan signal Vscs to the n-th row over a period from timing T55 immediately after the initialization of the post-stage node 340 to timing T57. The potential of the post-stage node 340 becomes the signal level Vsig. During exposure, the signal level is lower than the reset level, but during reading, the signal level is higher than the reset level because the post-stage node 340 is used as a reference. A difference between the reset level Vrst and the signal level Vsig corresponds to a net signal level from which reset noise and offset noise of the FD have been removed.

The DAC 213 gradually increases the ramp signal Rmp over a period from timing T56 after timing T55 to timing T57. The ADC 261 compares the ramp signal Rmp with a level Vrst′ of the vertical signal line 309, and counts a count value over a period until the comparison result is inverted. Therefore, the D-phase level (signal level) is read.

Furthermore, the vertical scanning circuit 211 controls the current source transistor 316 of the n-th row to be read over a period from timing T50 to timing T57 to supply the current id1. Furthermore, the timing control circuit 212 controls the load MOS transistors 251 of all the columns to supply the current id2 within the read period of all the rows.

Note that the solid-state imaging element 200 reads the signal level after the reset level, but is not limited to this order. The solid-state imaging element 200 can also read the reset level after the signal level. In this case, the vertical scanning circuit 211 is only required to supply the high-level scan signal Vscr after the high-level scan signal Vscs. Furthermore, in this case, it is necessary to reverse the gradient of the slope of the ramp signal.

Here, an imaging device having a configuration in which the sample hold circuit 320 and the determination circuit 360 are not arranged for each pixel is assumed as a comparative example. The imaging device of this comparative example further includes a frame memory.

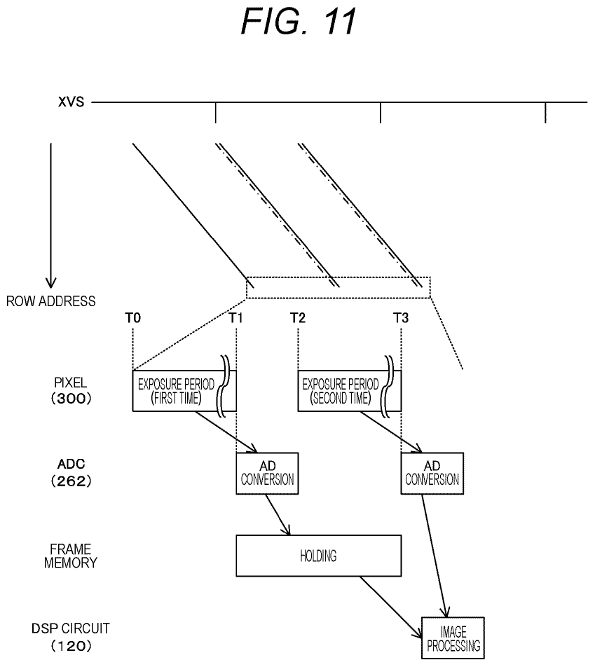

FIG. 11 is a timing chart illustrating an example of the operation of the imaging device according to the comparative example. In the comparative example, it is assumed that two images are subjected to comparative bright combination. Focusing on a certain row, the pixel 300 generates a pixel signal at a level corresponding to the exposure amount within the first exposure period from timing T0 to T1. In the exposure, for example, a rolling shutter method is used.

The ADC 262 performs AD conversion on the pixel signal of the focused row after timing T1. The frame memory holds first image data generated by AD conversion.

Then, the pixel 300 in the predetermined row generates a pixel signal at a level corresponding to the exposure amount within the second exposure period from timing T2 to timing T3.

The ADC 262 performs AD conversion on the pixel signal of the focused row after timing T3. The DSP circuit 120 reads the first image data from the frame memory and performs comparative bright combination with the second image data.

As illustrated in the drawing, in the comparative example in which the sample hold circuit 320 and the determination circuit 360 are not arranged, it is necessary to perform AD conversion on the pixel signal after both the first exposure and the second exposure. Furthermore, in the comparative example, it is necessary to hold the first image data in the frame memory until the second image data is generated. Therefore, as the number of sheets to be combined increases, the number of accesses to the frame memory and the number of times of AD conversion increase, and power consumption increases.

On the other hand, in the first embodiment in which the sample hold circuit 320 and the determination circuit 360 are arranged for each pixel, as illustrated in FIG. 6, the AD conversion may be performed only after the second exposure. In addition, since the pixel signal is held in the sample hold circuit 320, a frame memory is unnecessary. Therefore, the number of times of access to the frame memory and the number of times of AD conversion can be reduced as compared with the comparative example, and power consumption can be reduced.

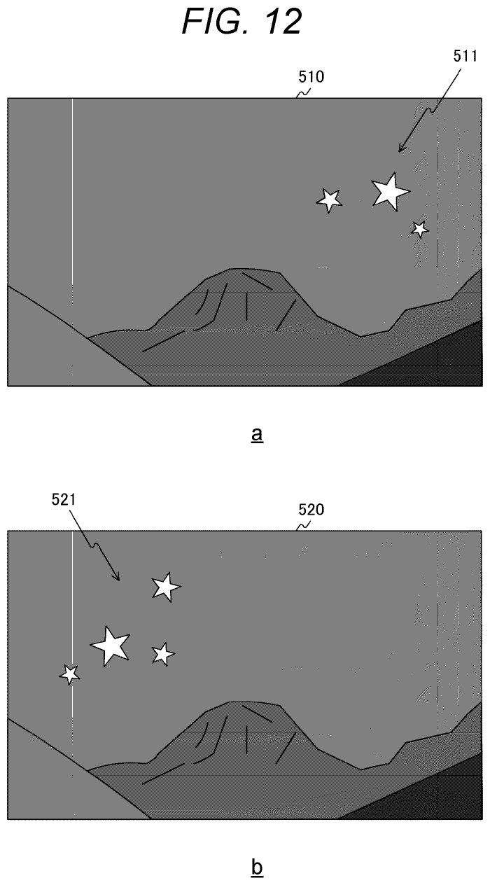

FIG. 12 is a diagram illustrating an example of image data before composition according to a comparative example, a in the drawing is an example of the first image data 510, and b in the drawing is an example of the second image data 520. The number of sheets to be combined is two.

As illustrated in a of the drawing, in the first image data 510, a star 511 with relatively high luminance is captured on the upper right. The image data 510 is held in a frame memory or the like.

Furthermore, as illustrated in b of the drawing, in the second image data 520, a bright star 521 with luminance is captured on the upper left. The imaging device of the comparative example reads the image data 510 from the frame memory and performs comparative bright combination with the image data 520.

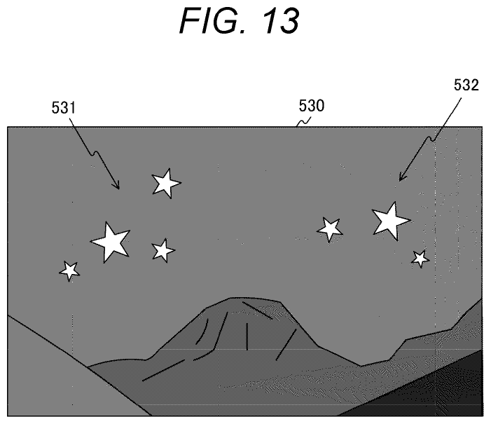

FIG. 13 is a diagram illustrating an example of combined image data 530 according to the first embodiment and the comparative example of the present technology. The bright pixel portion in the first image data 510 is combined with the second image data. As a result, as illustrated in the drawing, image data 530 in which stars 531 and 532 are illustrated on the upper left and the upper right is generated.

On the other hand, a case is assumed where imaging is performed by the imaging device 100 of the first embodiment under the same imaging condition. In the first embodiment, unlike the comparative example, the signal of each pixel in the first image data 510 is not AD-converted, and is held in the sample hold circuit 320 of each pixel. Furthermore, in the first embodiment, the second image data 520 illustrated in b of FIG. 12 is not generated, and the image data 530 of the composite image illustrated in FIG. 13 is generated by AD conversion. Therefore, the first AD conversion and the access to the frame memory are unnecessary, and the power consumption can be reduced when the composite image is generated.

Note that, as described above, the solid-state imaging element 200 does not perform AD conversion on the images from the first image to the (K−1)th image at the time of combining the K images, but may perform AD conversion on the images and output the converted images together with the composite image. At that time, the reading control illustrated in FIG. 10 is executed at the time of determination from the first time to the (K−1)th time. For example, it can be used in a use case of capturing a time-lapse moving image and capturing a composite image obtained by comparative bright combination of a plurality of images in the moving image. Even in a case where AD conversion is performed on the first to (K−1)th images, access to the frame memory is not necessary, so that power consumption can be reduced as compared with the comparative example.

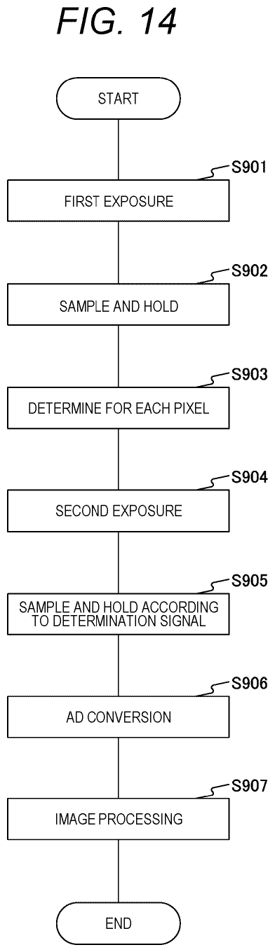

FIG. 14 is a flowchart illustrating an example of the operation of the solid-state imaging element 200 according to the first embodiment of the present technology. This operation is started when a predetermined application for capturing an image obtained by comparative bright combination is executed. The number of sheets to be combined is two.

The solid-state imaging element 200 performs the first exposure by the global shutter method (step S901), and samples and holds the pixel signal for each pixel (step S902). For each pixel, the determination circuit 360 determines whether or not the level of the pixel signal is higher than a threshold value (step S903).

Next, the solid-state imaging element 200 performs the second exposure by the global shutter method (step S904), and samples and holds the pixel signal according to the determination signal (step S905). In the second sample hold, the held value of the pixel whose level of the pixel signal is equal to or lower than the threshold value is updated.

Then, the solid-state imaging element 200 performs AD conversion on each of the pixel signals generated by the second exposure (step S906), and performs various types of image processing on the image data (step S907). After step S907, the imaging device 100 ends the operation for capturing the composite image.

As described above, according to the first embodiment of the present technology, the determination circuit 360 determines whether or not the signal level is higher than the threshold value for each pixel, and each pixel updates the held value according to the determination signal. Therefore, the number of accesses to the frame memory and the number of times of AD conversion can be reduced. This makes it possible to reduce power consumption when generating a composite image.

### First Modification Example

In the first embodiment described above, the determination circuit 360 and the AND gates 371 and 372 are arranged for each pixel, but in this configuration, the circuit scale of the pixel is increased by the circuits. A solid-state imaging element 200 in a first modification of the first embodiment is different from that of the first embodiment in that a pixel array section 220 is divided into a plurality of regions, and a determination circuit 360 and the like are arranged for each region.

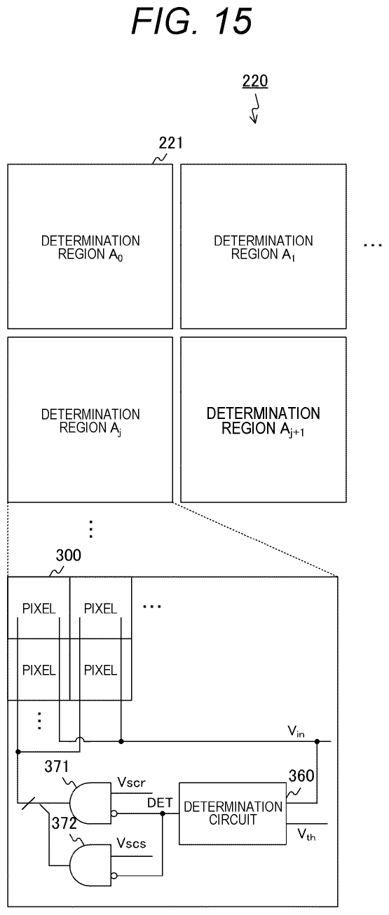

FIG. 15 is a diagram illustrating a configuration example of the pixel array section 220 according to the first modification of the first embodiment of the present technology. The pixel array section 220 according to the first modification of the first embodiment is divided into a plurality of determination regions. The number of determination regions is J (J is an integer of 2 or more), and the j-th (j is an integer from 0 to J−1) determination region is Aj.

In each of the determination regions, a plurality of pixels 300, a determination circuit 360, and AND gates 371 and 372 are arranged. The pixels 300 in the determination region are commonly connected to the determination circuit 360 and the AND gates 371 and 372, and share these circuits.

The determination circuit 360 compares the average value of the signal levels of the pixels in the corresponding determination region with a threshold value, and generates a determination signal DET.

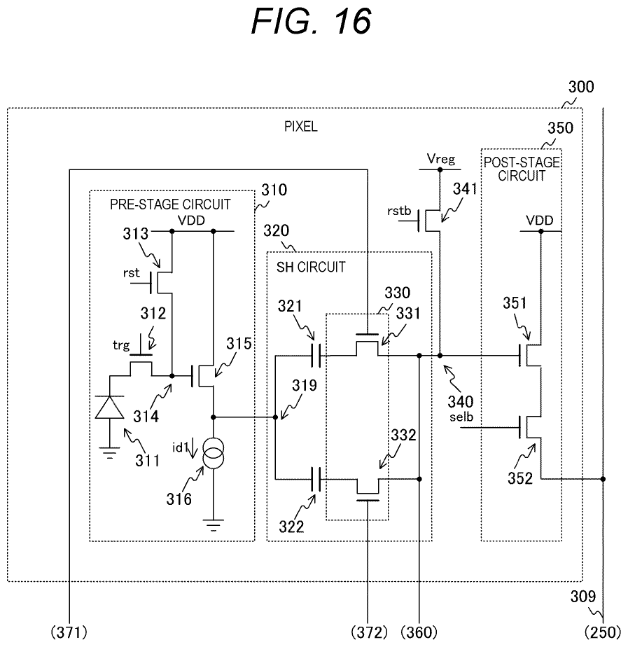

FIG. 16 is a circuit diagram illustrating a configuration example of the pixel 300 according to the first modification example of the first embodiment of the present technology. The pixel 300 according to the first modification of the first embodiment is different from that of the first embodiment in that the determination circuit 360 and the AND gates 371 and 372 are not arranged.

The gates of the selection transistors 331 and 332 are connected to the AND gates 371 and 372 shared by the determination regions. In addition, the post-stage node 340 is connected to the determination circuit 360 shared by the determination regions.

As illustrated in FIGS. 15 and 16, by sharing the determination circuit 360 and the like among the pixels in the determination region, the circuit scale of the pixels can be reduced as compared with the case where the determination circuit 360 and the like are arranged for each pixel.

Note that, although the determination circuit 360 and all of the AND gates 371 and 372 are shared in the determination region, only the determination circuit 360 may be shared, and the AND gates 371 and 372 may be arranged for each pixel.

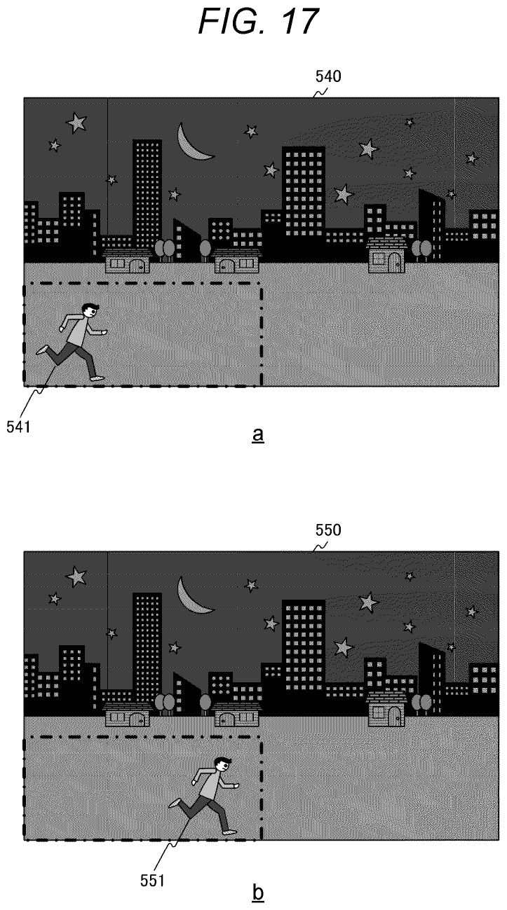

FIG. 17 is a diagram illustrating an example of image data before composition according to the first modification of the first embodiment of the present technology. In the drawing, a illustrates an example of the first image data 540. In the drawing, b illustrates an example of the second image data 550. The number of sheets to be combined is two.

In the imaging device, a predetermined region can be set as a region of interest (ROI) to be combined according to a user's operation or the like. The solid-state imaging element 200 performs comparative bright combination in the ROI, and does not perform comparative bright combination outside the ROI. For example, the solid-state imaging element 200 always sets the clear signal clr to the high level for the determination region outside the ROI until the composite image is generated. As a result, the held value is updated outside the ROI regardless of the signal level.

A region surrounded by a long dashed short dashed line in the first image data 540 is set as the ROI. It is assumed that the subject 541 is captured in the ROI. Since the signal level of the subject 541 is higher than the threshold value, the determination circuit 360 for the determination region corresponding to the subject generates the high-level determination signal DET.

In addition, in the second piece of imaging data 550, a region surrounded by a long dashed short dashed line is set as the ROI. It is assumed that the subject 551 is captured in the ROI. Since the signal level of the subject 551 is higher than the threshold value, the determination circuit 360 for the determination region corresponding to the subject generates the high-level determination signal DET.

However, in the modification of the first embodiment, the first image data 540 is not subjected to AD conversion and is held in the sample hold circuit 320 of each pixel. In addition, the second image data 550 is not actually generated, and image data obtained by combining the image data 540 and 550 is generated. For convenience of description, b of the drawing virtually illustrates image data in a case where the second image is captured without being combined.

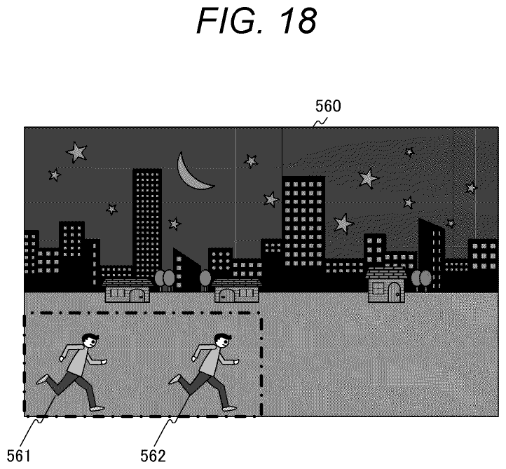

FIG. 18 is a diagram illustrating an example of combined image data 560 according to the first modification of the first embodiment of the present technology. The second image data 560 corresponds to image data obtained by comparative bright combination of the regions of the ROIs of the image data 540 and 550. The comparative bright combination generates a composite image in which the subjects 561 and 562 corresponding to the subjects 541 and 551 are illustrated in the ROI. The processing of performing the comparative bright combination in the ROI described above can be used in a use case such as a monitoring camera.

Note that the solid-state imaging element 200 can perform AD conversion on the entire image data 550 and output the converted image data, or can perform AD conversion on only the ROI and output the converted image data.

As described above, according to the first modification of the first embodiment of the present technology, since the determination circuit 360 and the AND gates 371 and 372 are shared by the pixels in the determination region, the circuit scale of the pixels can be reduced as compared with a case where they are not shared.

### Second Modification Example

In the first embodiment described above, the vertical scanning circuit 211 supplies the pulses of the scan signals Vscr and vscs at both the sample timing and the read timing, but it is also possible to supply the pulses only at the sample timing. A solid-state imaging element 200 according to a second modification of the first embodiment is different from that of the first embodiment in that scan signals Vscr and vscs indicating sample timings and control signals Ør and @s indicating read timings are used.

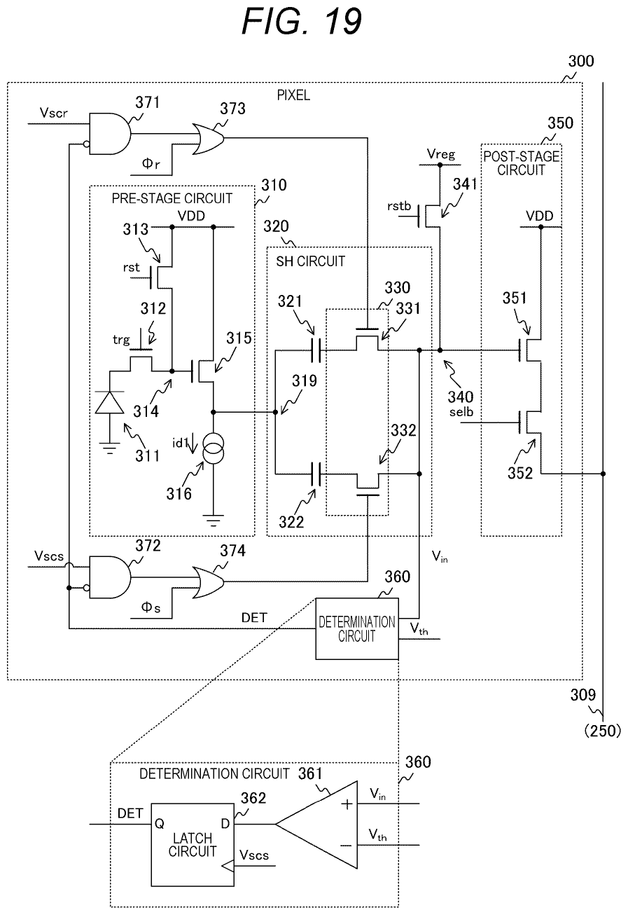

FIG. 19 is a circuit diagram illustrating a configuration example of the pixel 300 according to the second modification example of the first embodiment of the present technology. The pixel 300 according to the second modification of the first embodiment is different from that of the first embodiment in further including OR (logical sum) gates 373 and 374.

In addition, the latch circuit 362 of the second modification of the first embodiment does not have the clear terminal, and the clear signal clr is not input. Since initialization by the clear signal clr is unnecessary, the circuit configuration of the latch circuit 362 can be simplified.

The OR gate 373 supplies a logical sum of the control signal Ør and the output signal of the AND gate 371 to the gate of the selection transistor 331. The OR gate 374 supplies a logical sum of the control signal @s and the output signal of the AND gate 372 to the gate of the selection transistor 332. The control signal Ør is a pulse signal indicating a reset level read timing, and the control signal ϕs is a pulse signal indicating a signal level read timing.

Note that the AND gates 371 and 372 are an example of a pre-stage logic gate described in the claims, and the OR gates 373 and 374 are an example of a post-stage logic gate described in the claims.

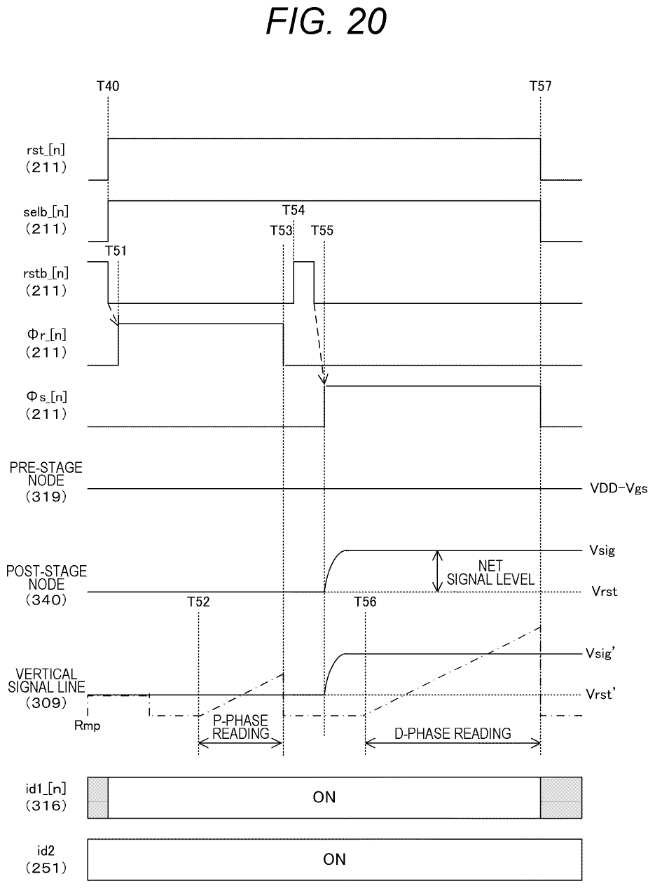

FIG. 20 is a timing chart illustrating an example of a read operation according to the second modification example of the first embodiment of the present technology. In the second modification of the first embodiment, control signals or and @s are supplied instead of the scan signals Vscr and Vscs. In addition, the clear signal clr is not supplied.

Note that the first modification can be applied to the second modification of the first embodiment. In this case, the OR gates 373 and 374 are also shared in the determination region.

As described above, according to the second modification of the first embodiment of the present technology, since the control signals or and @s are used at the time of reading, the clear signal clr is unnecessary, and the circuit configuration of the latch circuit 362 can be simplified.

### 2. Second Embodiment

In the first embodiment described above, the analog pixel signal is compared with the threshold value. However, in this configuration, it is necessary to arrange the determination circuit 360 for each pixel, and the circuit scale of the pixel is increased by the amount of the determination circuit 360. A solid-state imaging element 200 according to a second embodiment is different from that of the first embodiment in that a determination circuit 360 in a pixel is reduced by comparing a digital signal with a threshold value.

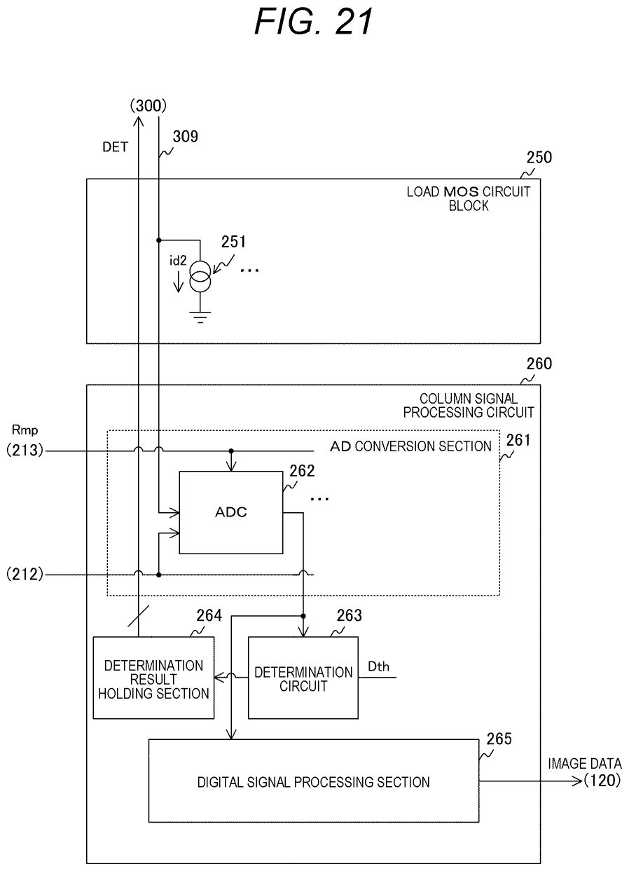

FIG. 21 is a block diagram illustrating a configuration example of a load MOS circuit block 250 and a column signal processing circuit 260 according to the second embodiment of the present technology. The column signal processing circuit 260 in the second embodiment is different from that in the first embodiment in that a determination circuit 263 and a determination result holding section 264 are further arranged for each column. In a case where the number of columns is M, M determination circuits 263 and determination result holding sections 264 are arranged.

In addition, in a case where the number of images to be combined is K, the AD conversion is not performed on the respective images up to the (K−1)th image in the first embodiment, but these images are also subjected to the AD conversion in the second embodiment. The read control illustrated in FIG. 10 is performed at each determination up to (K−1)th.

In FIG. 21, the determination circuit 263 compares the digital signal from the ADC 262 with a digital value Dth indicating a threshold value. The determination circuit 263 determines whether or not the digital signal is larger than a threshold value for each row in each of the (K−1)th images and supplies the determination signal DET to the determination result holding section 264. In a case where the number of rows is N, N determination signals DET are generated for each exposure. Unlike the determination circuit 360, the determination circuit 263 does not need to include a latch circuit, and for example, a comparator can be used as the determination circuit 263.

The determination result holding section 264 holds a determination signal DET for each row. In a case where the number of rows is N, N latch circuits are arranged in the determination result holding section 264. Each of the latch circuits supplies a held value to a pixel of a corresponding row. The circuit configuration of each latch circuit is, for example, similar to the latch circuit 362 illustrated in FIG. 3. In addition, a register can be used as the determination result holding section 264. In this case, a flip-flop is arranged instead of the latch circuit.

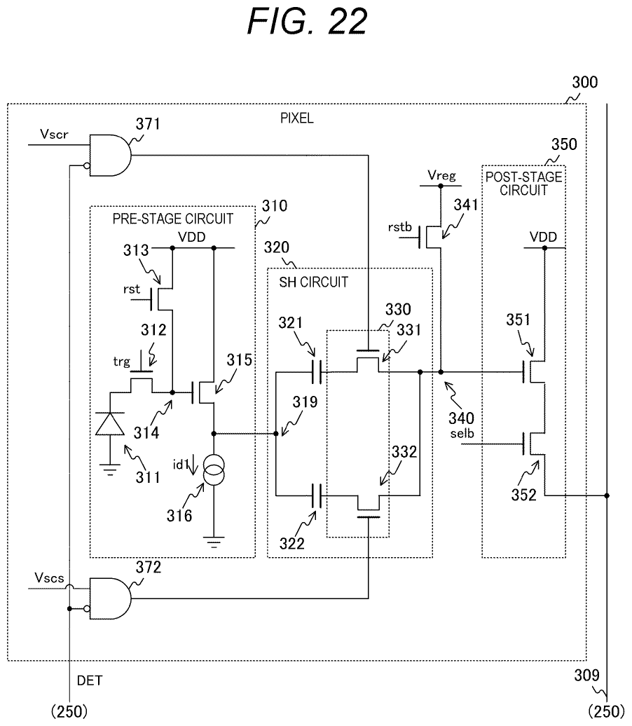

FIG. 22 is a circuit diagram illustrating a configuration example of the pixel 300 according to the second embodiment of the present technology. The pixel 300 of the second embodiment is different from that of the first embodiment in that the determination circuit 360 is not arranged. The determination signal DET from the determination result holding section 264 is input to the AND gates 371 and 372 of the second embodiment via the load MOS circuit block 250.

Since the determination circuit 263 compares the digital signal with the threshold value, it is not necessary to arrange the determination circuit 360 for each pixel as illustrated in the drawing, and the circuit scale of the pixel 300 can be reduced.

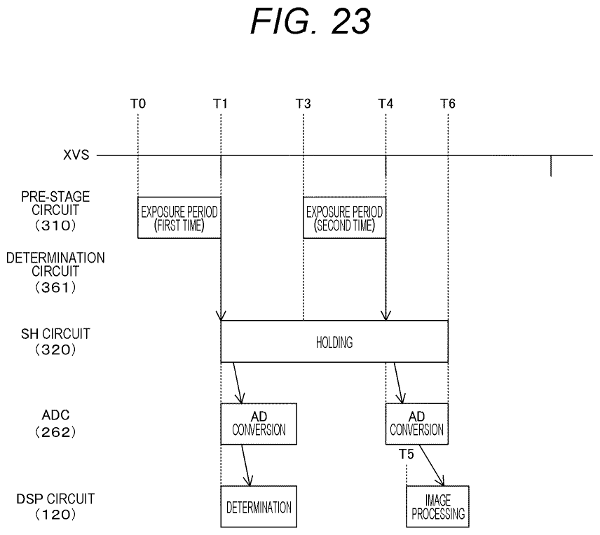

FIG. 23 is a timing chart illustrating an example of the operation of the imaging device 100 according to the second embodiment of the present technology. It is assumed that the number of sheets to be combined is two. The pre-stage circuit 310 of all the pixels generates a pixel signal at a level corresponding to the exposure amount within the first exposure period from timing T0 to T1.

The rows are sequentially selected within the read period from timing T1, and the ADC 262 performs AD conversion on the pixel signals of the selected rows. In addition, the determination circuit 263 performs determination for each row. As illustrated in the drawing, in the second embodiment, the first image is also AD-converted.

Then, the pre-stage circuit 310 of all the pixels generates a pixel signal at a level corresponding to the exposure amount within the second exposure period from timing T3 to T4.

The rows are sequentially selected within the period from timing T4 to timing T6, and the ADC 262 performs AD conversion on the pixel signals of the selected rows. After timing T5, the DSP circuit 120 performs various image processing on the image data generated by the AD conversion.

Note that the first modification of the first embodiment can be applied to the second embodiment. In this case, for example, the determination circuit 263 is arranged for each determination region, and the determination circuit 263 calculates an average value of digital signals of each pixel in the corresponding determination region and compares the average value with a threshold value.

Furthermore, the second modification of the first embodiment can also be applied to the second embodiment.

As described above, according to the second embodiment of the present technology, since the determination circuit 263 compares the digital signal with the threshold value, the determination circuit 360 in the pixel can be reduced.

### Modifications

In the second embodiment described above, the determination result holding section 264 that holds the determination signal DET for each row is arranged for each column, but in this configuration, it is necessary to wire a signal line that transmits the determination signal DET for each row between the determination result holding section 264 and the corresponding column. For example, in a case where the number of rows is N, the vertical signal line 309 for transmitting the pixel signal and the N signal lines for transmitting the determination signal DET need to be wired for each column. A solid-state imaging element 200 according to a modification of the second embodiment is different from that of the second embodiment in that a latch circuit is arranged for each pixel to reduce the number of wirings.

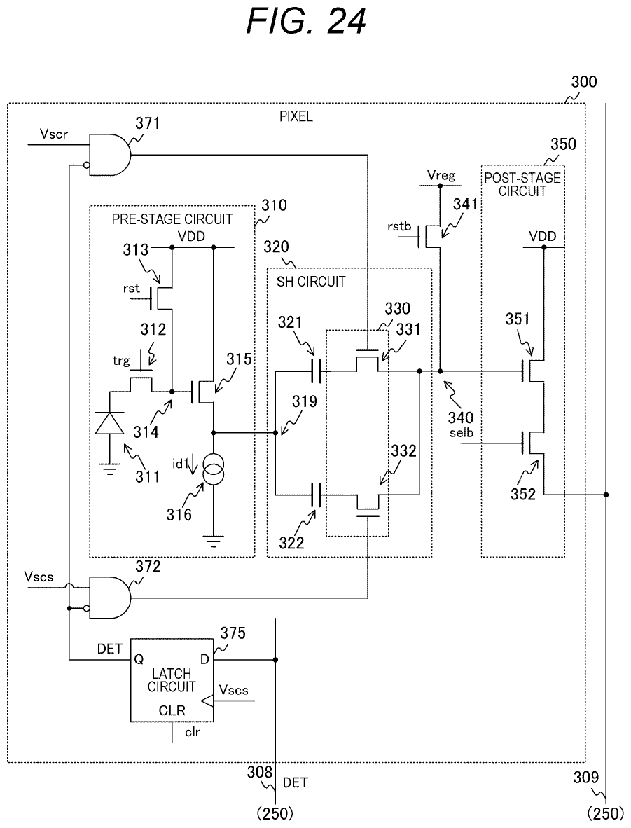

FIG. 24 is a circuit diagram illustrating a configuration example of a pixel 300 according to a modification of the second embodiment of the present technology. The pixel 300 according to the modification of the second embodiment is different from that of the second embodiment in further including a latch circuit 375.

In addition, in the modification of the second embodiment, the determination result holding section 264 is not arranged in the column signal processing circuit 260. Furthermore, the vertical signal line 308 for transmitting the determination signal DET and the vertical signal line 309 for transmitting the pixel signal are wired for each column. The determination circuit 263 of the modification of the second embodiment outputs the determination signal DET to the vertical signal line 308.

The latch circuit 375 holds the determination signal DET from the vertical signal line 308. The circuit configuration of the latch circuit 375 is similar to that of the latch circuit 362 illustrated in FIG. 3.

Note that the first and second modifications of the first embodiment can be applied to the modification of the second embodiment.

As described above, according to the modification of the second embodiment of the present technology, since the latch circuit 375 is arranged for each pixel, the number of wirings in the vertical direction can be reduced.

### 3. Third Embodiment

In the first embodiment described above, the determination signal DET is generated by comparing the pixel signal with the threshold value for each pixel.

However, in this configuration, it is necessary to arrange the determination circuit 360 for each pixel, and the circuit scale of the pixel is increased by the amount of the determination circuit 360. An imaging device 100 according to the third embodiment is different from that of the first embodiment in that a DSP circuit 120 generates a determination signal DET.

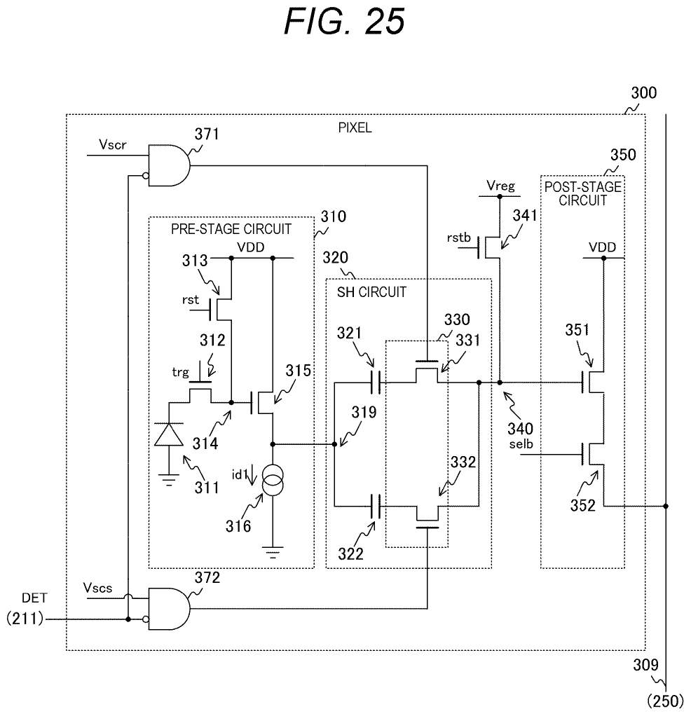

FIG. 25 is a circuit diagram illustrating a configuration example of a pixel 300 according to the third embodiment of the present technology. The pixel 300 of the third embodiment is different from that of the first embodiment in that the determination circuit 360 is not arranged.

The vertical scanning circuit 211 of the third embodiment receives the determination signal DET for each pixel from the DSP circuit 120 and supplies the determination signal DET to each pixel. The determination signal DET from the vertical scanning circuit 211 is input to the AND gates 371 and 372 of the third embodiment.

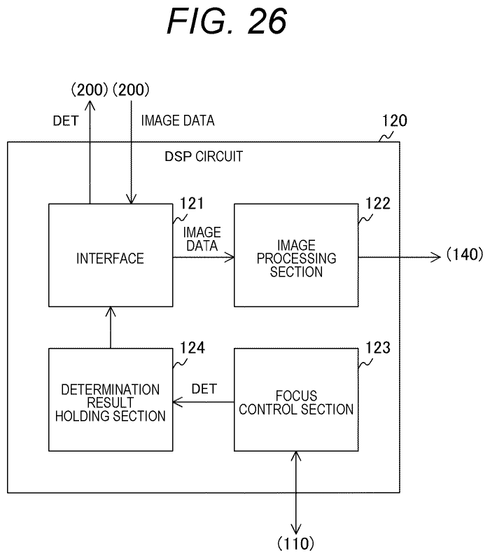

FIG. 26 is a block diagram illustrating a configuration example of the DSP circuit 120 according to the third embodiment of the present technology. The DSP circuit 120 includes an interface 121, an image processing section 122, a focus control section 123, and a determination result holding section 124.

The interface 121 transmits and receives data such as image data and a determination signal DET to and from the solid-state imaging element 200. The image processing section 122 performs various image processing such as demosaic processing and white balance correction on the image data from the solid-state imaging element 200.

The focus control section 123 detects a position of a lens in focus on a predetermined subject by a phase difference AF method or the like. The focus control section 123 moves the lens in the optical section 110 to the detected position to perform focusing. At this time, the focus control section 123 determines a pixel in the focused subject as a pixel whose held value is not updated. Pixels in a subject that is out of focus are determined as pixels whose held values are to be updated. The focus control section 123 generates a determination signal DET for each pixel and supplies the determination signal DET to the determination result holding section 124.

The determination result holding section 124 holds a determination signal for each pixel. In the determination result holding section 124, when the number of pixels is N×M, N×M latch circuits are arranged. Each latch circuit supplies a held value to the solid-state imaging element 200 via the interface 121. The circuit configuration of each latch circuit is, for example, similar to the latch circuit 362 illustrated in FIG. 3. Note that these latch circuits can also be arranged in the pixel as illustrated in FIG. 24. In addition, a register can be used as the determination result holding section 124. In this case, a flip-flop is arranged instead of the latch circuit.

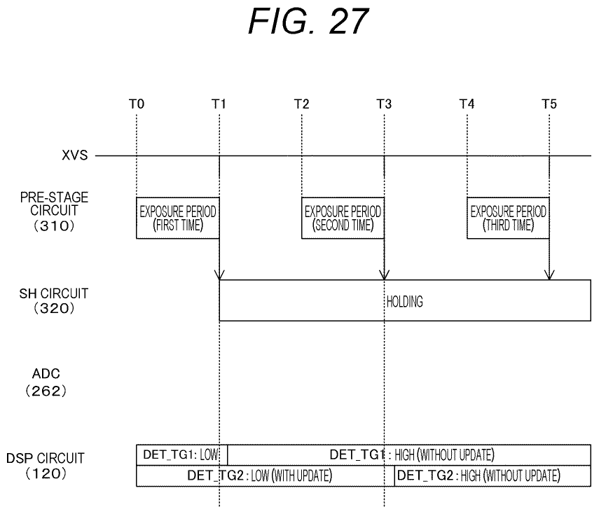

FIG. 27 is a timing chart illustrating an example of imaging operation until third exposure of the imaging device 100 according to the third embodiment of the present technology.

In the third embodiment, the imaging device 100 can generate a composite image focused on a plurality of subjects as necessary. Whether or not to generate such a composite image is manually set by a user operation, for example. Alternatively, the DSP circuit 120 detects an imaging scene, and automatically sets whether or not to perform composition on the basis of the detection result. For example, the number of sheets to be combined is four.

During the period from timing T0 to timing T1, the DSP circuit 120 in the imaging device 100 detects the position of the lens in focus on the predetermined subject TG1 by, for example, the phase difference AF method. Note that a contrast AF method can be used instead of the phase difference AF method. In the case of using the contrast AF method, a plurality of pieces of image data is captured before timing T0, and a contrast value of each piece of image data is calculated.

Then, the DSP circuit 120 moves the lens to the detected position to perform focusing. It is assumed that focusing is performed immediately after timing T1, and at this time, the DSP circuit 120 determines a pixel in the focused subject TG1 as a pixel whose held value is not updated. When the determination signal corresponding to each pixel in the subject TG1 is DET_TG1, a high level is set to the determination signal DET_TG1.

A subject TG2 different from the subject TG1 is also present within the imaging range, but it is assumed that the subject TG2 is not in focus at the time of the first and second exposures. The DSP circuit 120 determines a pixel in the subject TG2 that is out of focus as a pixel whose held value is to be updated. When a determination signal corresponding to each pixel in the subject TG2 is DET_TG2, a low level is set to the determination signal DET_TG2.

In addition, during the first exposure period from timing T0 to T1, a pixel signal at a level corresponding to the exposure amount is generated. At the end of the exposure, the sample hold circuits 320 of all the pixels sample and hold the first pixel signal.

Subsequently, during a period from immediately after timing T1 to T3, the DSP circuit 120 detects a position of a lens in focus on the subject TG2 by a phase difference AF method or the like, and moves the lens to the position. It is assumed that the focus is achieved immediately after timing T3, and at that time, the DSP circuit 120 sets the determination signal DET_TG2 to the high level. At this time, although the subject TG1 is not in focus, since the value (high level) of the determination signal of the subject in focus even once is held in the determination result holding section 124, the determination signal DET_TG1 remains at the high level.

In addition, during the second exposure period from timing T2 to T3, a pixel signal at a level corresponding to the exposure amount is generated. At the end of the exposure, the sample hold circuits 320 of all the pixels sample and hold the second pixel signal. However, at timing T3, the determination signal DET_TG1 is set to the high level, and the determination signal DET_TG2 is set to the low level. Therefore, the sample hold circuit 320 does not update the held value of the pixel corresponding to the determination signal DET_TG1, but updates the held value of the pixel corresponding to the determination signal DET_TG2. Note that it is assumed that the subjects other than the subjects TG1 and TG2 are not in focus, and a low level is set to the determination signal DET.

Then, during the third exposure period from timing T4 to timing T5, a pixel signal at a level corresponding to the exposure amount is generated. At the end of the exposure, the sample hold circuits 320 of all the pixels sample and hold the third pixel signal. However, at timing T5, the determination signals DET_TG1 and DET_TG2 are set to the high level. Therefore, the sample hold circuit 320 does not update the held values of the pixels corresponding to the determination signals DET_TG1 and DET_TG2, but updates the held values of the pixels in another subject.

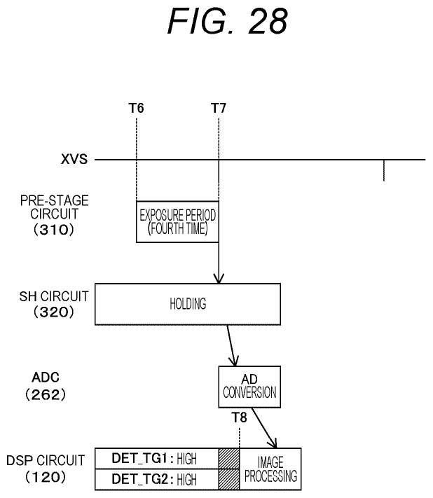

FIG. 28 is a timing chart illustrating an example of imaging operation at the time of fourth exposure of the imaging device 100 according to the third embodiment of the present technology.

During the fourth exposure period from timing T6 to timing T7, a pixel signal at a level corresponding to the exposure amount is generated. At the end of the exposure, the sample hold circuits 320 of all the pixels sample and hold the fourth pixel signal.

The rows are sequentially selected after timing T7, and the ADC 262 performs AD conversion on the pixel signals of the selected row. Immediately before timing T8, the determination signals such as the determination signals DET_TG1 and DET_TG2 are initialized to the low level. In the drawing, a hatched portion indicates a low level. After timing T8, the DSP circuit 120 performs various image processing on the image data generated by the AD conversion. This image data is data of a composite image focused on both subjects TG1 and TG2.

As illustrated in FIGS. 27 and 28, it is possible to generate a composite image focused on a plurality of subjects by updating the held values of the other pixels without updating the held values of the pixels in the focused subject at the end of the second and subsequent exposures.

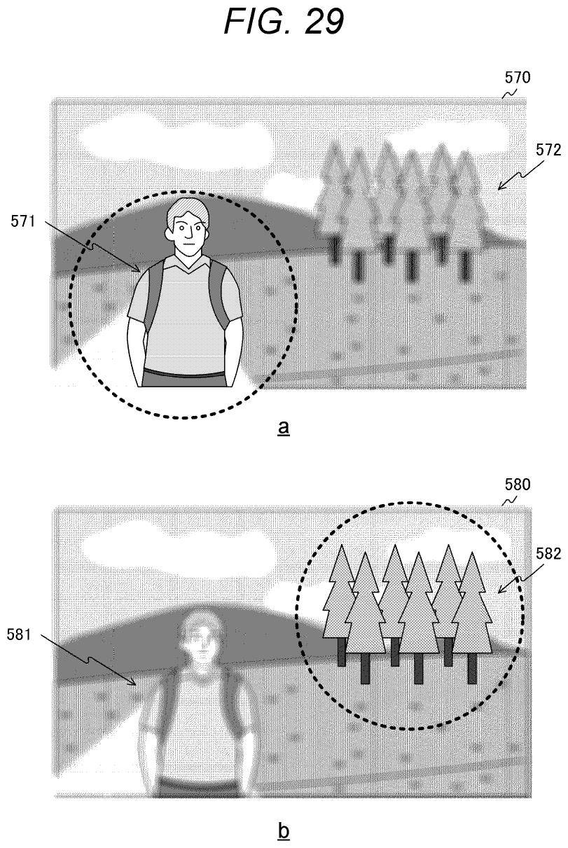

FIG. 29 is a diagram illustrating an example of image data before composition according to the third embodiment of the present technology. In the drawing, a is an example of the first image data 570, and b in the drawing is an example of the second image data 580.

As illustrated in a of the drawing, the solid-state imaging element 200 captures the image data 570 by exposure of the global shutter method. The image data 570 includes subjects 571 and 572. It is assumed that the subject 571 in the dotted line is in focus and the subject 572 is not in focus when the image data 570 is captured. The DSP circuit 120 sets a determination signal corresponding to a pixel of the focused subject 571 to a high level, and sets a determination signal of another subject such as the subject 572 to a low level. Next, as illustrated in b of the drawing, the solid-state imaging element 200 captures the image data 580 by exposure of the global shutter method. The image data 580 includes subjects 581 and 582. The subject 581 is the same as the subject 571 in the previous imaging, and the subject 582 is the same as the subject 572 in the previous imaging.

The DSP circuit 120 changes a subject to be focused. It is assumed that the subject 582 in the dotted line is in focus and the subject 581 is not in focus when the image data 570 is captured. The DSP circuit 120 sets the determination signal corresponding to the pixel of the focused subject 582 to the high level. The determination signal corresponding to the pixel of the previously focused subject 581 remains at the high level. The determination signals corresponding to the pixels other than the subjects 581 and 582 remain at the low level.

Note that the image data 570 illustrated in a of the drawing is not output from the solid-state imaging element 200, and a pixel signal in the image data is held in the sample hold circuit 320 of each pixel. The image data 580 illustrated in b of the drawing is not actually generated, and image data obtained by combining the image data 570 and 580 is generated. For convenience of description, b of the drawing virtually illustrates image data in a case where the second image is captured without being combined.

Furthermore, the image data illustrated in the drawing is obtained by fixing and imaging the imaging device 100, but the user can also perform an operation (in other words, panning or tilting) of shaking the imaging device 100 left and right or up and down while fixing the focus point at the time of composition. In a case where panning or tilting is performed while the focus point is fixed, a subject different from a subject before panning or tilting may be in focus. In this case, the DSP circuit 120 is only required to analyze data from an acceleration sensor or a gyro sensor in the imaging device 100 to acquire a rotation direction and an angle of the imaging device 100, obtain a subject in focus after panning or tilting, and generate a determination signal.

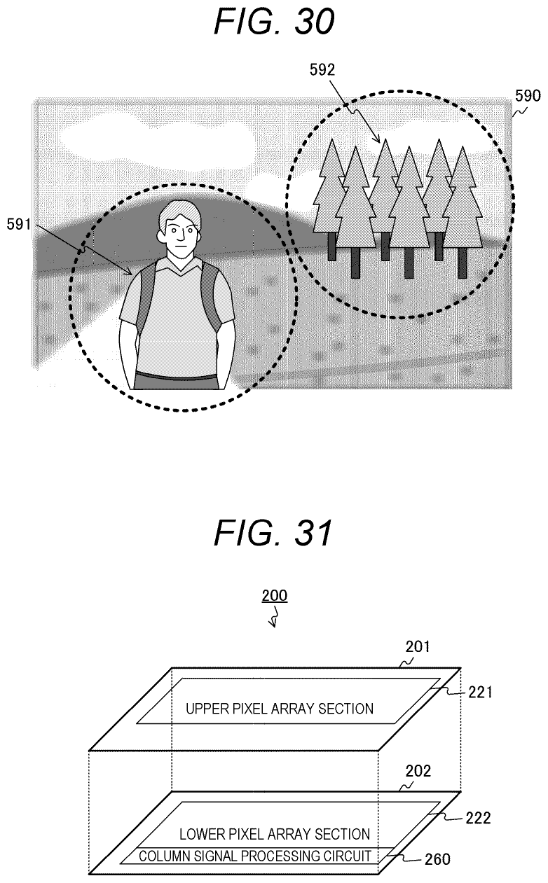

FIG. 30 is a diagram illustrating an example of image data after composition according to the third embodiment of the present technology. After capturing the image data 570 in a of FIG. 29, the solid-state imaging element 200 captures the image data 590 by exposure of the global shutter method. The image data 590 includes subjects 591 and 592. The subject 591 is the same as the subjects 571 and 581 in the previous imaging, and the subject 592 is the same as the subjects 572 and 582 in the previous imaging.

As described above, the imaging device 100 focuses on the subject 571 by the first imaging, and does not update the pixels in the subject at the time of the first sample hold. In addition, the imaging device 100 focuses on the subject 582 by the second imaging, and does not update the pixels in the subjects 581 and 582 at the time of the second sample hold. With this control, the image data 590 focused on both subjects 581 and 582 corresponding to the subjects 591 and 592 is generated. The image data 590 corresponds to an image obtained by combining a focused portion of the first image data 570 with the second image data 580.

Note that the first and second modification examples of the first embodiment can be applied to the third embodiment.

As described above, according to the third embodiment of the present technology, since the DSP circuit 120 generates the determination signal DET depending on whether or not focusing has been performed, it is possible to generate a composite image focused on a plurality of subjects. In addition, it is not necessary to arrange the determination circuit 360 in the pixel, and the circuit scale of the pixel can be reduced.

### 4. Fourth Embodiment

In the first embodiment described above, the circuits in the solid-state imaging element 200 are provided in a single semiconductor chip, but there is a possibility that this configuration prevents the elements from fitting in the semiconductor chip in a case where the pixel 300 is miniaturized. A solid-state imaging element 200 in a fourth embodiment is different from that in the first embodiment in that circuits in the solid-state imaging element 200 are dispersedly arranged on two semiconductor chips.

FIG. 31 is a diagram illustrating an example of a laminated structure of the solid-state imaging element 200 according to the fourth embodiment of the present technology. The solid-state imaging element 200 of the fourth embodiment includes a lower pixel chip 202 and an upper pixel chip 201 laminated on the lower pixel chip 202. These chips are electrically connected by, for example, Cu—Cu bonding. Note that, in addition to the Cu—Cu bonding, the connection can be made using a via or a bump.

An upper pixel array section 221 is arranged in the upper pixel chip 201. A lower pixel array section 222 and the column signal processing circuit 260 are arranged in the lower pixel chip 202. For each pixel in the pixel array section 220, a part of the pixel is arranged in the upper pixel array section 221, and the rest is arranged in the lower pixel array section 222.

Furthermore, in the lower pixel chip 202, the vertical scanning circuit 211, the timing control circuit 212, the DAC 213, and the load MOS circuit block 250 are also arranged. These circuits are not illustrated in the drawing.

In addition, the upper pixel chip 201 is manufactured, for example, by a pixel-dedicated process, and the lower pixel chip 202 is manufactured, for example, by a complementary MOS (CMOS) process. Note that the upper pixel chip 201 is an example of the first chip described in the claims, and the lower pixel chip 202 is an example of the second chip described in the claims.

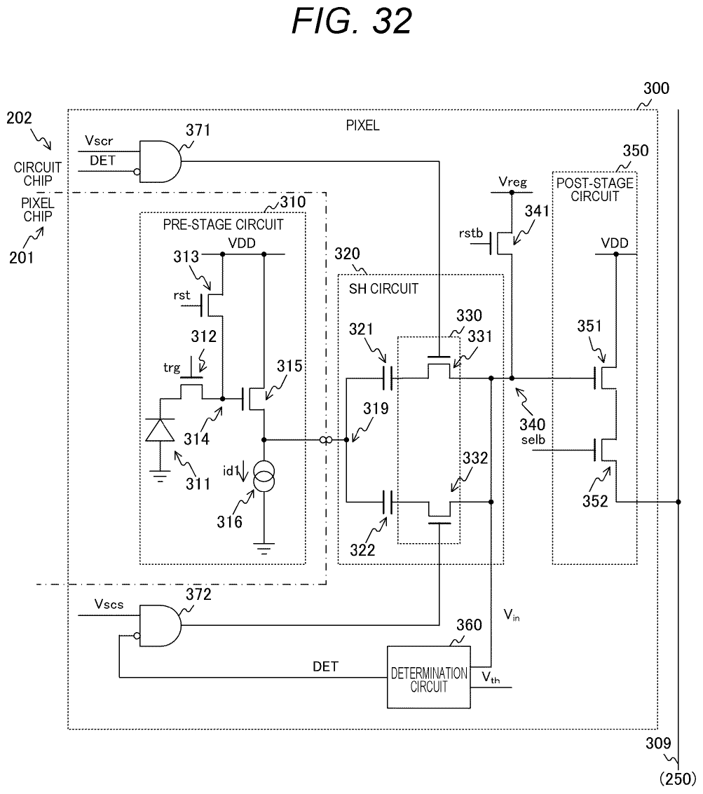

FIG. 32 is a circuit diagram illustrating a configuration example of the pixel 300 according to the fourth embodiment of the present technology. Among the pixels 300, the pre-stage circuit 310 is arranged on the upper pixel chip 201, and the other circuits and elements (the determination circuit 360, the AND gate 371, and the like) are arranged on the lower pixel chip 202. Note that the current source transistor 316 can be further arranged in the lower pixel chip 202. As illustrated in the drawing, dispersedly arranging the elements in the pixel 300 in the upper pixel chip 201 and lower pixel chip 202 laminated on top of each other allows a reduction in pixel area, thereby facilitating pixel miniaturization.

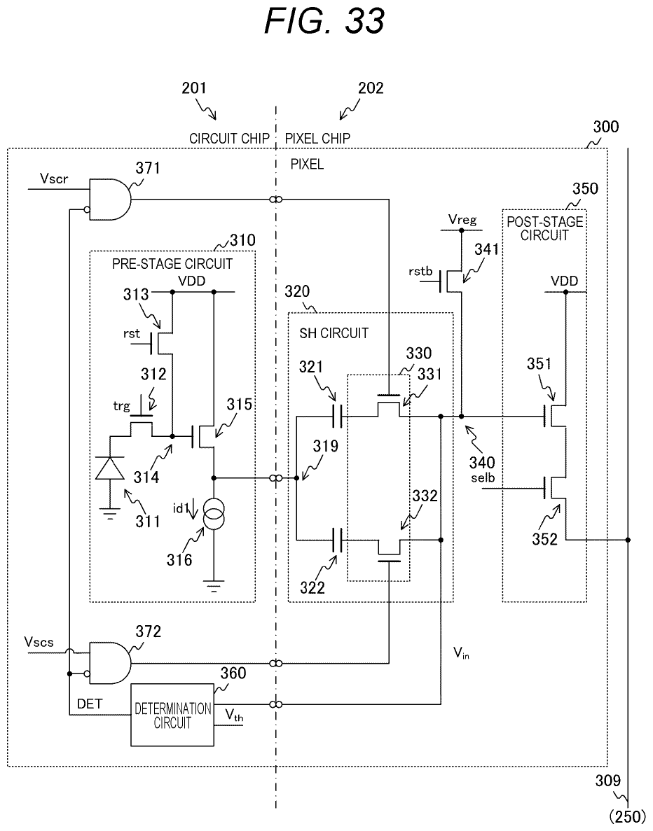

Furthermore, as illustrated in FIG. 33, the AND gates 371 and 372 and the determination circuit 360 can be arranged on the upper pixel chip 201.

Note that the first and second modifications and the second and third embodiments of the first embodiment can be applied to the fourth embodiment.

As described above, according to the fourth embodiment of the present technology, since the circuits and elements in the pixel 300 are dispersedly arranged on the two semiconductor chips, miniaturization of the pixel is facilitated.

### Modifications

In the above-described fourth embodiment, a part of the pixel 300 and the peripheral circuit (such as the column signal processing circuit 260) are provided in the lower pixel chip 202 on the lower side. However, in this configuration, the arrangement area of the circuits and elements on the lower pixel chip 202 side is larger than the arrangement area of the upper pixel chip 201 by the peripheral circuit, and there is a possibility that an unnecessary space without circuits and elements is generated in the upper pixel chip 201. A solid-state imaging element 200 according to a modification of the fourth embodiment is different from that of the fourth embodiment in that circuits in the solid-state imaging element 200 are dispersedly arranged on three semiconductor chips.

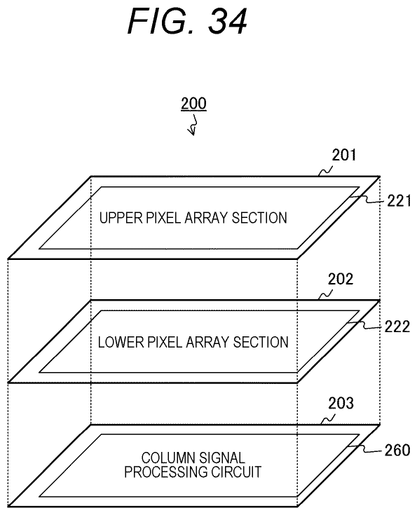

FIG. 34 is a diagram illustrating an example of a laminated structure of the solid-state imaging element 200 according to the modification of the fourth embodiment of the present technology. The solid-state imaging element 200 according to the modification of the fourth embodiment includes an upper pixel chip 201, a lower pixel chip 202, and a circuit chip 203. These chips are laminated and are electrically connected by, for example, Cu—Cu bonding. Note that, in addition to the Cu—Cu bonding, the connection can be made using a via or a bump.

An upper pixel array section 221 is arranged in the upper pixel chip 201. The lower pixel array section 222 is arranged in the lower pixel chip 202. For each pixel in the pixel array section 220, a part of the pixel is arranged in the upper pixel array section 221, and the rest is arranged in the lower pixel array section 222.

In addition, in the circuit chip 203, the column signal processing circuit 260, the vertical scanning circuit 211, the timing control circuit 212, the DAC 213, and the load MOS circuit block 250 are arranged.

Circuits other than the column signal processing circuit 260 are not illustrated in the drawing.

Adopting the three-layer configuration as illustrated in the drawing allows a reduction in unnecessary space and allows further pixel miniaturization as compared with the two-layer configuration. In addition, the lower pixel chip 202 that is the second layer can be manufactured by a dedicated process for capacitors and switches.

Note that the first and second modifications and the second and third embodiments of the first embodiment can be applied to the modification of the fourth embodiment.

As described above, in the modification of the fourth embodiment of the present technology, since the circuits in the solid-state imaging element 200 are dispersedly arranged on the three semiconductor chips, the pixels can be further miniaturized as compared with a case where the circuits are dispersedly arranged on the two semiconductor chips.

### 5. Fifth Embodiment

In the first embodiment described above, the pre-stage circuit 310 reads a signal with the pre-stage circuit 310 connected to the pre-stage node 319, but this configuration cannot block noise from the pre-stage node 319 at the time of reading. The pixel 300 in the fifth embodiment is different from that in the first embodiment in that a transistor is inserted between the pre-stage circuit 310 and the pre-stage node 319.

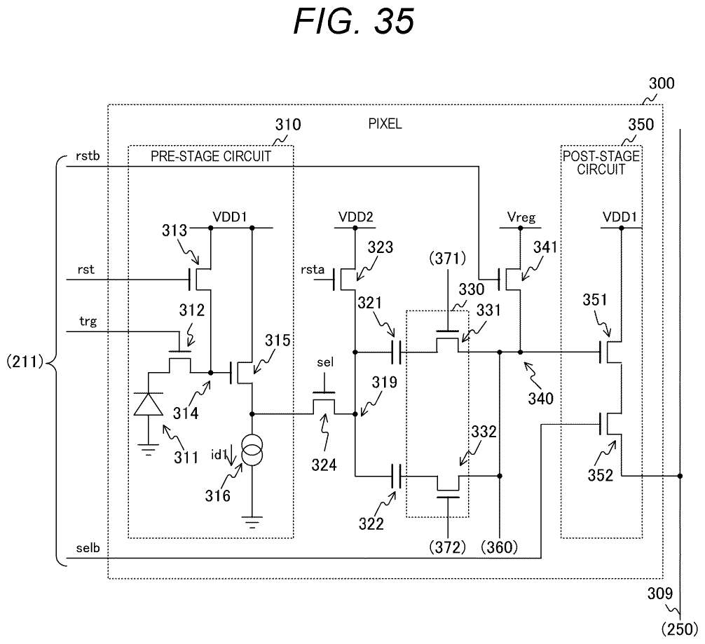

FIG. 35 is a circuit diagram illustrating a configuration example of the pixel 300 according to the fifth embodiment of the present technology. The pixel 300 of the fifth embodiment is different from that of the first embodiment in that the sample hold circuit 320 further includes a pre-stage reset transistor 323 and a pre-stage selection transistor 324. In addition, the power supply voltages of the pre-stage circuit 310 and the post-stage circuit 350 of the fifth embodiment are VDD1.

The pre-stage reset transistor 323 initializes the level of the pre-stage node 319 with a power supply voltage VDD2. It is desirable that the power supply voltage VDD2 be set to a value satisfying the following expression.

$$VDD 2 = VDD 1 - Vgs \qquad Expression 1$$

In the above expression, Vgs indicates the gate-source voltage of the pre-stage amplification transistor 315.

Setting to the value satisfying Expression 1 allow a reduction in variations in potential between the pre-stage node 319 and the post-stage node 340 in the dark. It is therefore possible to improve photo response non-uniformity (PRNU).

The pre-stage selection transistor 324 opens and closes a path between the pre-stage circuit 310 and the pre-stage node 319 in accordance with a pre-stage selection signal sel from the vertical scanning circuit 211.

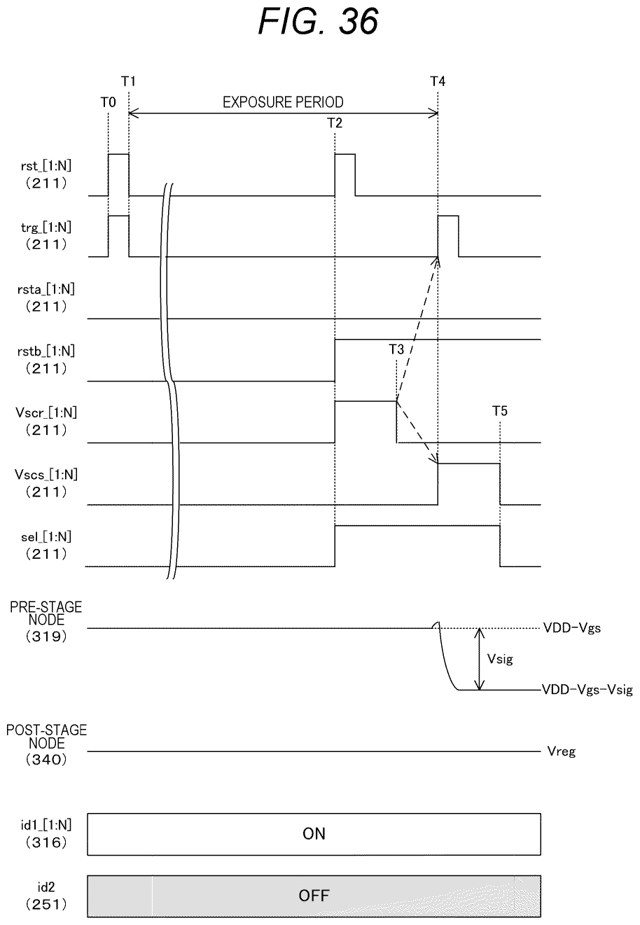

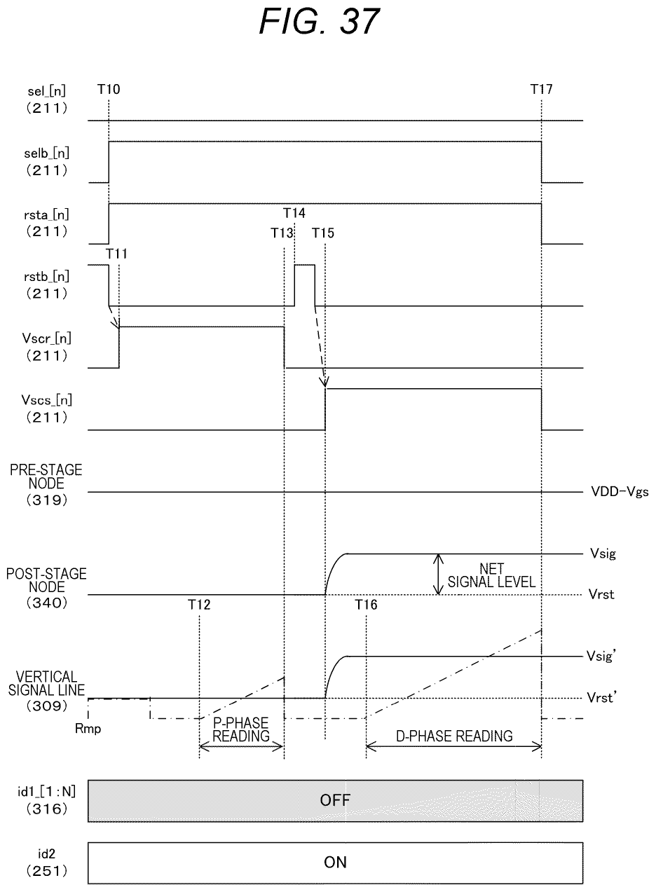

FIG. 36 is a timing chart illustrating an example of a global shutter operation according to the fifth embodiment of the present technology. The timing chart of the fifth embodiment is different from that of the first embodiment in that the vertical scanning circuit 211 further supplies a pre-stage reset signal rsta and a pre-stage selection signal sel. In the drawing, rsta_[n] and sel_[n] indicate signals to pixels in the n-th row.

The vertical scanning circuit 211 supplies a high-level pre-stage selection signal sel to all the pixels over a period from timing T2 immediately before the end of exposure to timing T5. The pre-stage reset signal rsta is controlled to the low level.

FIG. 37 is a timing chart illustrating an example of a read operation according to the fifth embodiment of the present technology. At the time of reading of each row, the pre-stage selection signal sel is controlled to the low level. This control brings the pre-stage selection transistor 324 into the open state to disconnect the pre-stage node 319 from the pre-stage circuit 310. It is therefore possible to block noise from the pre-stage node 319 at the time of reading.

Furthermore, over the read period of the n-th row from timing T10 to timing T17, the vertical scanning circuit 211 supplies a high-level pre-stage reset signal rsta to the n-th row.

Furthermore, at the time of reading, the vertical scanning circuit 211 controls the current source transistors 316 of all the pixels to stop the supply of the current id1. The current id2 is supplied in a manner similar to the first embodiment. As described above, the control of the current id1 is simplified as compared with the first embodiment.

Note that the first and second modifications and the second to fourth embodiments of the first embodiment can be applied to the fifth embodiment.

As described above, according to the fifth embodiment of the present technology, the pre-stage selection transistor 324 shifts to the open state at the time of reading and separates the pre-stage circuit 310 from the pre-stage node 319, so that noise from the pre-stage circuit 310 can be cut off.

### 6. Sixth Embodiment

In the first embodiment described above, the reset level is sampled and held in the exposure period, but this configuration prevents the exposure period from being shorter than the sample and hold period of the reset level. A solid-state imaging element 200 of a sixth embodiment is different from the solid-state imaging element 200 of the first embodiment in that a transistor that discharges charges from a photoelectric conversion element is added to make the exposure period shorter.

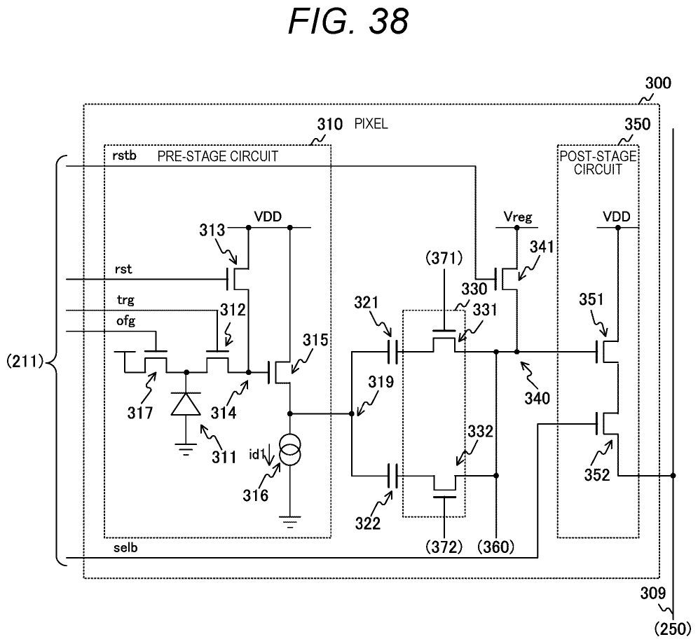

FIG. 38 is a circuit diagram illustrating a configuration example of the pixel 300 according to the sixth embodiment of the present technology. The pixel 300 of this sixth embodiment is different from the pixel 300 of the first embodiment in that a discharge transistor 317 is further provided in the pre-stage circuit 310.

The discharge transistor 317 functions as an overflow drain that discharges charges from the photoelectric conversion element 311 in accordance with a discharge signal ofg from the vertical scanning circuit 211. As the discharge transistor 317, for example, an nMOS transistors is used.

The configuration without the discharge transistor 317 as in the first embodiment may suffer blooming when charges are transferred from the photoelectric conversion element 311 to the FD 314 for all the pixels. Then, at the time of FD reset, the potential of the FD 314 and the potential of the pre-stage node 319 drop. In response to the potential drop, charging and discharging currents of the capacitor elements 321 and 322 continue to occur, and IR drop in the power supply or the ground changes from a steady state without blooming.

On the other hand, at the time of sampling and holding the signal levels of all the pixels, after the transfer of the signal charges, the photoelectric conversion element 311 has no charge, so that blooming does not occur, and IR drop in the power supply or the ground goes into the steady state without blooming. Due to a difference in IR drop at the time of sampling and holding the reset level and the signal level, streaking noise occurs.

On the other hand, in the sixth embodiment in which the discharge transistor 317 is provided, the charges in the photoelectric conversion element 311 are discharged toward the overflow drain. Therefore, IR drops at the time of sampling and holding the reset level and the signal level become almost identical to each other, so that it is possible to suppress streaking noise.

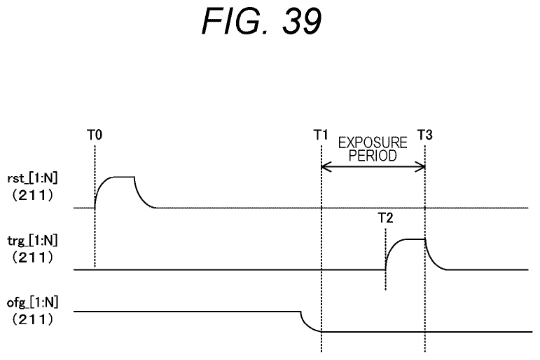

FIG. 39 is a timing chart illustrating an example of a global shutter operation according to the sixth embodiment of the present technology. At timing T0 before the start of exposure, the vertical scanning circuit 211 supplies the high-level FD reset signal rst to all the pixels over the pulse period while setting the discharge signal ofg to the high level for all the pixels. Therefore, the PD reset and the FD reset are performed on all the pixels. Furthermore, the reset level is sampled and held. Here, ofg_[n] in the drawing indicates signals to pixels in the n-th row of the N rows.

Then, at timing T1 that is the start of exposure, the vertical scanning circuit 211 returns the discharge signal ofg to the low level for all the pixels. Then, the vertical scanning circuit 211 supplies the high-level transfer signal trg to all the pixels over a period from timing T2 immediately before the end of exposure to timing T3 that is the end of exposure. As a result, the signal level is sampled and held.

The configuration without the discharge transistor 317 as in the first embodiment needs to bring both the transfer transistor 312 and the FD reset transistor 313 into the on state at the start of exposure (that is, at the time of PD reset). Under this control, the FD 314 also needs to be reset at the time of PD reset. It is therefore necessary to perform the FD reset again within the exposure period to sample and hold the reset level, so that the exposure period cannot be made shorter than the sample and hold period of the reset level. When the reset levels of all the pixels are sampled and held, a certain waiting time is required until the voltage and the current settle, and for example, a sample and hold period of several microseconds (μs) to several tens of microseconds (μs) is required.

On the other hand, in the sixth embodiment in which the discharge transistor 317 is provided, the PD reset and the FD reset can be separately performed. Therefore, as illustrated in the drawing, it is possible to sample and hold the reset level by performing the FD reset before termination of the PD reset (the start of exposure). It is therefore possible to make the exposure period shorter than the sample and hold period of the reset level.

Note that the first and second modifications and the second to fifth embodiments of the first embodiment can be applied to the sixth embodiment.

As described above, according to the sixth embodiment of the present technology, since the discharge transistor 317 that discharges charges from the photoelectric conversion element 311 is provided, it is possible to sample and hold the reset level by performing the FD reset before the start of exposure. It is therefore possible to make the exposure period shorter than the sample and hold period of the reset level.

### 7. Seventh Embodiment

In the first embodiment described above, the FD 314 is initialized with the power supply voltage VDD, but there is a possibility that this configuration causes deterioration of photo response non-uniformity (PRNU) due to variations of the capacitor elements 321 and 322 or parasitic capacitance. A solid-state imaging element 200 of this seventh embodiment is different from the solid-state imaging element 200 of the first embodiment in that PRNU is improved by lowering the power supply of the FD reset transistor 313 at the time of reading.

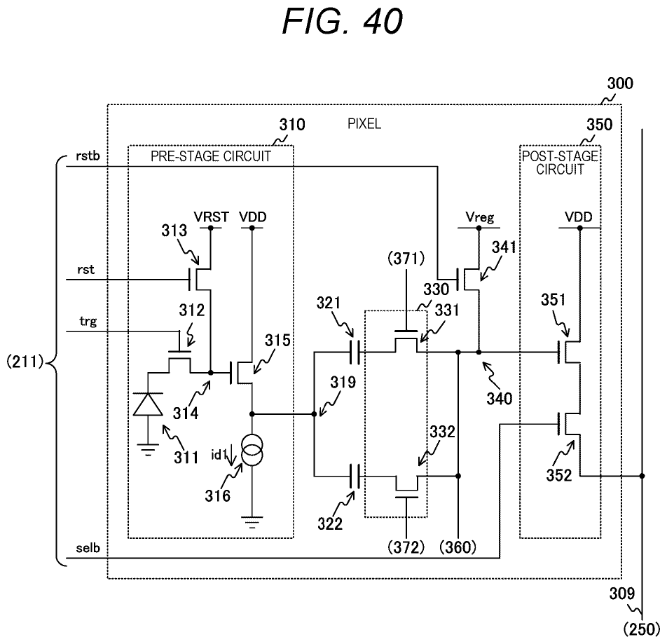

FIG. 40 is a circuit diagram illustrating a configuration example of the pixel 300 according to the seventh embodiment of the present technology. The pixel 300 of this seventh embodiment is different from the pixel 300 of the first embodiment in that the power supply of the FD reset transistor 313 is separated from the power supply voltage VDD of the pixel 300.

The FD reset transistor 313 of the seventh embodiment has a drain connected to a reset power supply voltage VRST. The reset power supply voltage VRST is controlled by, for example, the timing control circuit 212.

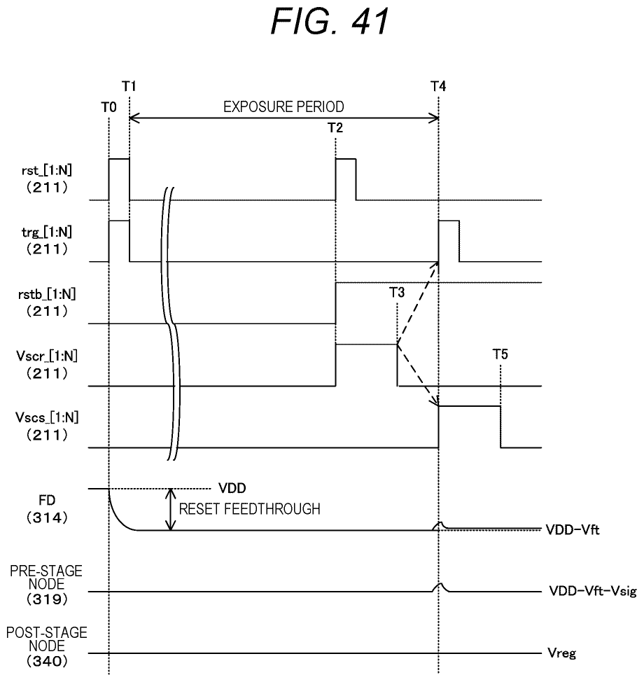

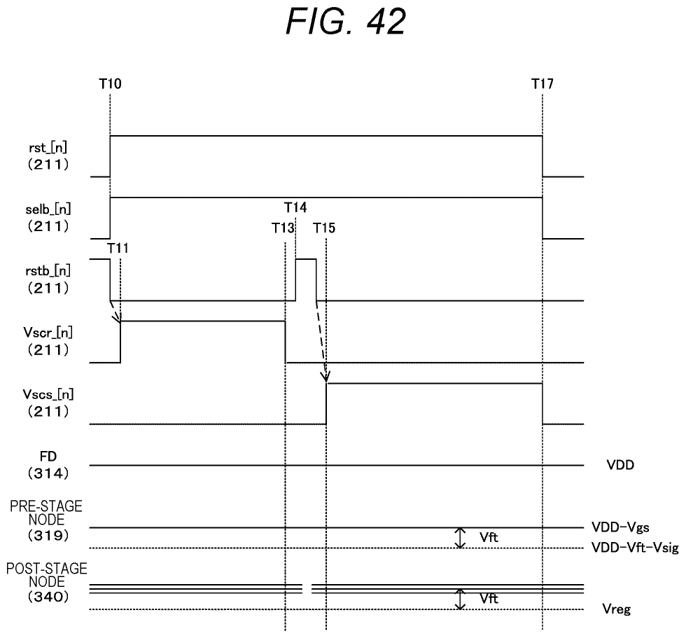

Here, consider deterioration of PRNU in the pixel 300 of the first embodiment with reference to FIGS. 41 and 42. In the first embodiment, as illustrated in FIG. 41, at timing T0 immediately before the start of exposure, the potential of the FD 314 decreases due to reset feedthrough of the FD reset transistor 313. This variation is denoted as Vft.

In the first embodiment, since the power supply voltage of the FD reset transistor 313 is VDD, the potential of the FD 314 varies from VDD to VDD−Vft at timing T0. Furthermore, the potential of the pre-stage node 319 at the time of exposure becomes equal to VDD−Vft−Vsig.

Furthermore, in the first embodiment, as illustrated in FIG. 42, the FD reset transistor 313 shifts to the on state at the time of reading to fix the FD 314 to the power supply voltage VDD. The potential of the pre-stage node 319 and the potential of the post-stage node 340 at the time of reading are shifted higher by about the variation Vft of the FD 314. However, due to variations in capacitance values of the capacitor elements 321 and 322 or parasitic capacitance, the shift voltage amount varies for each pixel, which causes deterioration of PRNU.

A shift amount of the post-stage node 340 in a case where the pre-stage node 319 is shifted by Vft is expressed by, for example, the following expression.

$$\{ ( Cs + δ Cs ) / ( Cs + δ Cs + Cp ) \} ⋆ Vft \qquad Expression 2$$

In the above expression, Cs is a capacitance value of the capacitor element 322 on the signal level side, and δCs is a variation in Cs. Cp is a capacitance value of the parasitic capacitance of the post-stage node 340.

Expression 2 can be approximated by the following expression.

$$\{ 1 - ( δ Cs / Cs ) * ( Cp / Cs ) \} ⋆ Vft \qquad Expression 3$$

From Expression 3, the variations of the post-stage node 340 can be expressed by the following expression.

$$\{ ( δ Cs / Cs ) * ( Cp / Cs ) \} ⋆ Vft \qquad Expression 4$$

With (Cs/Cs) set to 10⁻², (Cp/Cs) set to 10⁻¹, and Vft set to 400 millivolt (mV), PRNU is 400 μVrms according to Expression 4, which is a relatively large value.

In particular, in order to reduce kTC noise at the time of sampling and holding input conversion capacitance, it is necessary to increase a charge-voltage conversion efficiency of the FD 314. In order to increase the charge-voltage conversion efficiency, it is necessary to reduce the capacitance of the FD 314, but the smaller the capacitance of the FD 314, the larger the variation Vft, which may be several hundred millivolts (mV). In this case, PRNU impact may be non-negligible according to Expression 4.

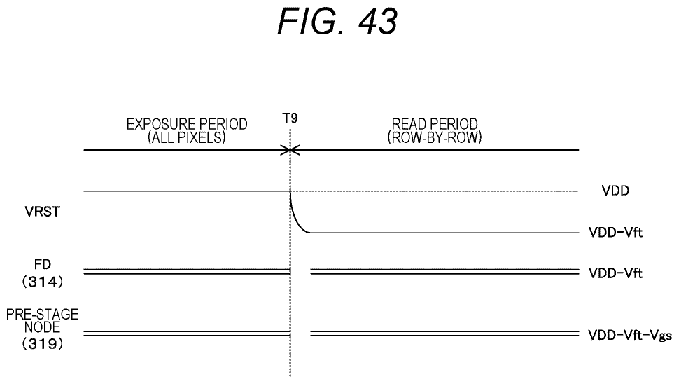

FIG. 43 is a timing chart illustrating an example of voltage control according to the seventh embodiment of the present technology.

The timing control circuit 212 performs control to make the reset power supply voltage VRST for the row-by-row read period after timing T9 different from the reset power supply voltage VRST for the exposure period.

For example, for the exposure period, the timing control circuit 212 sets the reset power supply voltage VRST identical to the power supply voltage VDD. On the other hand, for the read period, the timing control circuit 212 decreases the reset power supply voltage VRST to VDD-Vft. That is, for the read period, the timing control circuit 212 decreases the reset power supply voltage VRST by amount approximately equal to the variation Vft caused by reset feedthrough. This control allows the reset level of the FD 314 at the time of exposure and the reset level at the time of reading to be identical to each other.

Controlling the reset power supply voltage VRST allows, as illustrated in the drawing, a reduction in variations in voltage of the FD 314 and the pre-stage node 319. It is therefore possible to suppress variations of the capacitor elements 321 and 322 and deterioration of PRNU due to parasitic capacitance.

Note that the first and second modifications and the second to sixth embodiments of the first embodiment can be applied to the seventh embodiment.

As described above, according to the seventh embodiment of the present technology, since the timing control circuit 212 decreases the reset power supply voltage VRST by the variation Vft caused by reset feedthrough at the time of reading, it is possible to make the reset level at the time of exposure and the reset level at the time of reading identical to each other. It is therefore possible to suppress deterioration of photo response non-uniformity (PRNU).

### 8. Eighth Embodiment

In the first embodiment described above, the signal level is read next to the reset level every time the composite image (frame) is captured. However, in this configuration, there is a possibility that photo response non-uniformity (PRNU) deteriorates due to variations in the capacitor elements 321 and 322 or parasitic capacitance. A solid-state imaging element 200 according to an eighth embodiment is different from that of the first embodiment in improving a PRNU by switching a level held in a capacitor element 321 and a level held in a capacitor element 322 each time a frame is imaged.

The solid-state imaging element 200 according to the eighth embodiment continuously captures a plurality of composite images (frames) in synchronization with a vertical synchronization signal. An odd-numbered frame is referred to as “odd frame”, and an even-numbered frame is referred to as “even frame”. Note that the solid-state imaging element 200 can also capture a plurality of pieces of image data (frames) without combining.

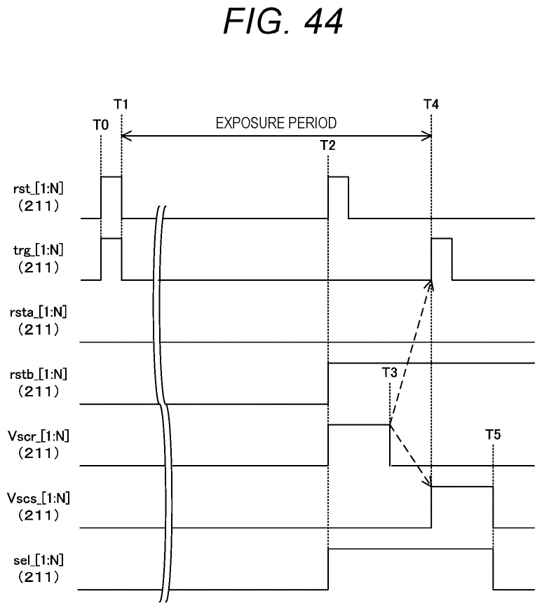

FIG. 44 is a timing chart illustrating an example of a global shutter operation for the odd frame according to the eighth embodiment of the present technology. The pre-stage circuit 310 in the solid-state imaging element 200 sets the scan signal Vscs to the high level next to the scan signal Vscr within the exposure period of the odd frame, thereby causing the capacitor element 321 to hold the reset level, and then causing the capacitor element 322 to hold the signal level.

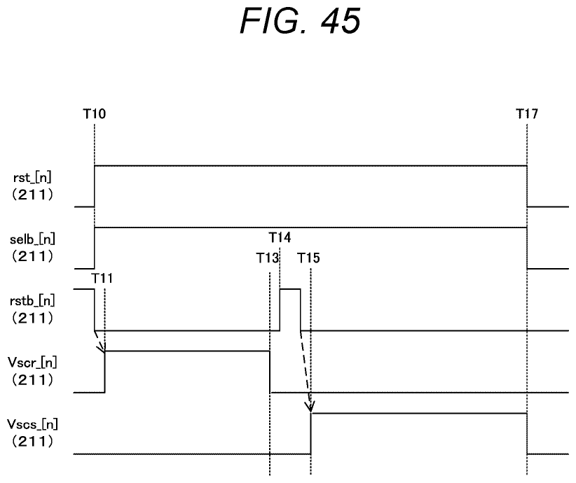

FIG. 45 is a timing chart illustrating an example of a read operation for the odd frame according to the eighth embodiment of the present technology. The post-stage circuit 350 in the solid-state imaging element 200 sets the scan signal Vscs to the high level next to the scan signal Vscr and reads the signal level next to the reset level within the read period of the odd frame.

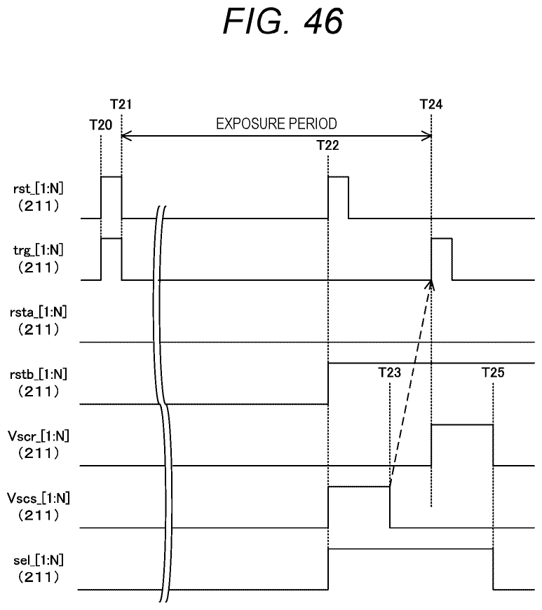

FIG. 46 is a timing chart illustrating an example of a global shutter operation for the even frame according to the eighth embodiment of the present technology. The pre-stage circuit 310 in the solid-state imaging element 200 sets the scan signal Vscr to the high level next to the scan signal Vscs within the exposure period of the even frame, thereby causing the capacitor element 322 to hold the reset level, and then causing the capacitor element 321 to hold the signal level.

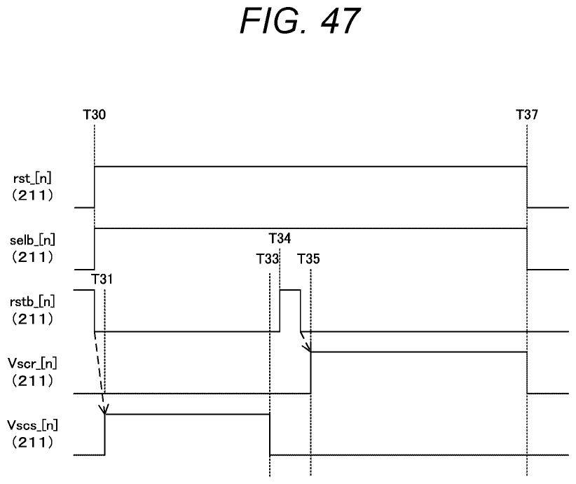

FIG. 47 is a timing chart illustrating an example of a read operation for the even frame according to the eighth embodiment of the present technology. The post-stage circuit 350 in the solid-state imaging element 200 sets the scan signal Vscr to the high level next to the scan signal Vscs and reads the signal level next to the reset level within the read period of the even frame.

As illustrated in FIGS. 44 and 46, the levels held in the capacitor elements 321 and 322 are reversed between the even frame and the odd frame. This also reverses the polarity of PRNU between the even frame and the odd frame. The column signal processing circuit 260 in the subsequent stage obtains the average of the odd frame and the even frame. It is therefore possible to cancel out PRNU with opposite polarities.

This control is effective in capturing a moving image or adding up frames. In addition, it is not necessary to add an element to the pixel 300, and it can be realized only by changing a driving method.

Note that the first and second modifications and the second to seventh embodiments of the first embodiment can be applied to the eighth embodiment.

As described above, in the eighth embodiment of the present technology, since the level held in the capacitor element 321 and the level held in the capacitor element 322 are reversed between the odd frame and the even frame, the polarity of PRNU can be reversed between the odd frame and the even frame. The column signal processing circuit 260 adds up the odd frame and the even frame, so that it is possible to suppress deterioration of PRNU.

### 9. Ninth Embodiment

In the first embodiment described above, the column signal processing circuit 260 obtains a difference between the reset level and the signal level for each column. There is, however, a possibility that this configuration suffers, when very high intensity light is incident on the pixel, a black spot phenomenon in which luminance decreases due to overflow of charges from the photoelectric conversion element 311 and sinks into black. A solid-state imaging element 200 of the ninth embodiment is different from the solid-state imaging element 200 of the first embodiment in that whether or not the black spot phenomenon has occurred is determined for each pixel.

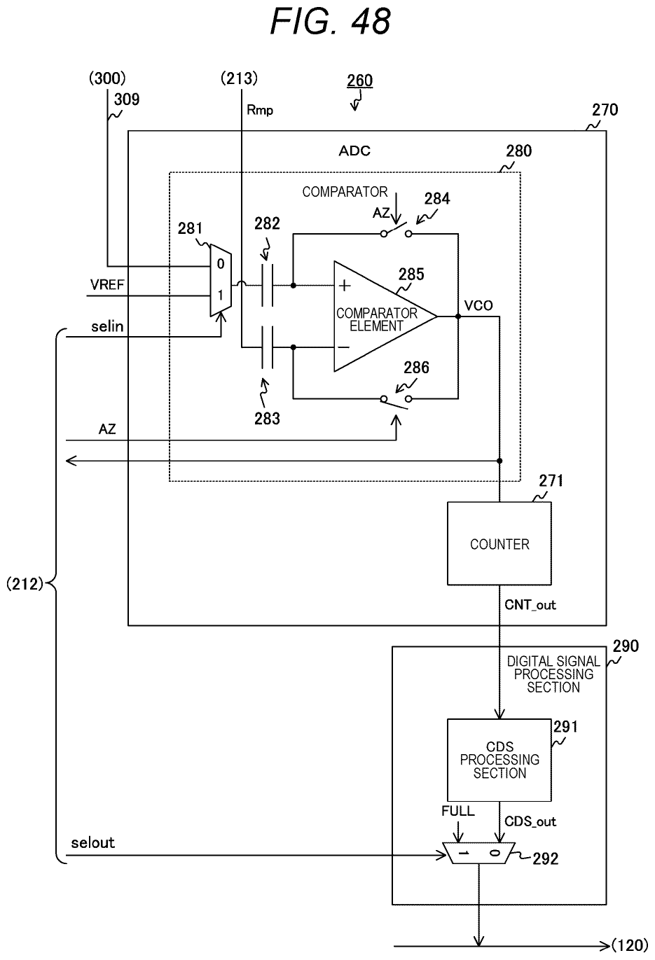

FIG. 48 is a circuit diagram illustrating a configuration example of the column signal processing circuit 260 according to the ninth embodiment of the present technology. In the column signal processing circuit 260 of the ninth embodiment, a plurality of ADCs 270 and a digital signal processing section 290 are arranged. In addition, in the digital signal processing section 290, a plurality of CDS processing sections 291 and a plurality of selectors 292 are arranged. The ADC 270, the CDS processing section 291, and the selector 292 are provided for each column.

In addition, the ADC 270 includes a comparator 280 and a counter 271. The comparator 280 compares the level of the vertical signal line 309 with the ramp signal Rmp from the DAC 213, and outputs a comparison result VCO. The comparison result VCO is supplied to the counter 271 and the timing control circuit 212. The comparator 280 includes a selector 281, capacitor elements 282 and 283, auto-zero switches 284 and 286, and a comparator element 285.

The selector 281 connects either the vertical signal line 309 of the corresponding column or a node of a predetermined reference voltage VREF to a non-inverting input terminal (+) of the comparator element 285 via the capacitor element 282 in accordance with an input-side selection signal selin. The input-side selection signal selin is supplied from the timing control circuit 212.

The comparator element 285 compares a level of the non-inverting input terminal (+) with a level of an inverting input terminal (−), and outputs the comparison result VCO to the counter 271. The ramp signal Rmp is input to an inverting input terminal (−) via the capacitor element 283.

The auto-zero switch 284 short-circuits the non-inverting input terminal (+) and an output terminal of the comparison result VCO in accordance with an auto-zero signal AZ from the timing control circuit 212. The auto-zero switch 286 short-circuits the inverting input terminal (−) and the output terminal of the comparison result VCO in accordance with the auto-zero signal Az.

The counter 271 counts a count value over a period until the comparison result VCO is inverted, and outputs a digital signal CNT_out indicating the count value to the CDS processing section 291.

The CDS processing section 291 performs CDS processing on the digital signal CNT_out. The CDS processing section 291 calculates a difference between the digital signal CNT_out corresponding to the reset level and the digital signal CNT_out corresponding to the signal level, and outputs the difference to the selector 292 as CDS_out.

The selector 292 outputs, in accordance with an output-side selection signal selout from the timing control circuit 212, either the digital signal CDS_out subjected to the CDS processing or a full-code digital signal FULL as pixel data of the corresponding column.

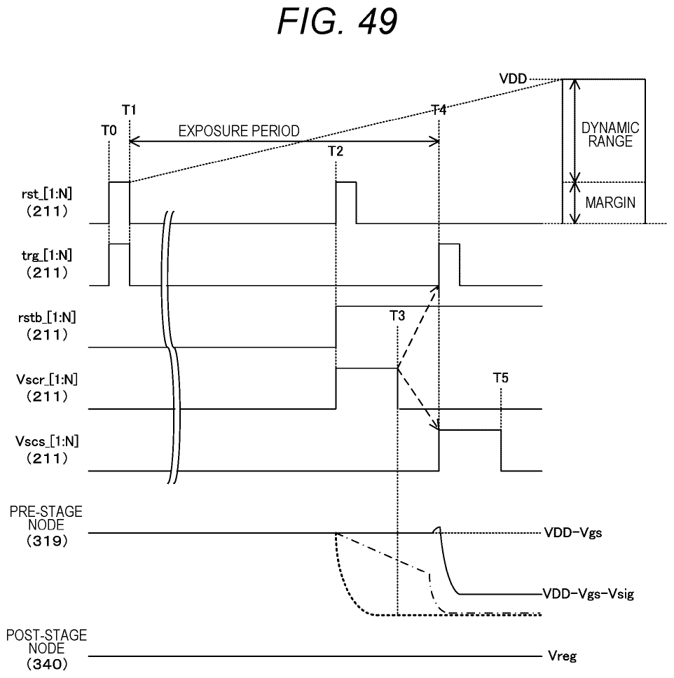

FIG. 49 is a timing chart illustrating an example of a global shutter operation according to the ninth embodiment of the present technology. A method for controlling transistors at the time of global shutter of the ninth embodiment is similar to the method of the first embodiment.

Here, it is assumed that very high intensity light is incident on the pixel 300. In this case, the photoelectric conversion element 311 becomes full of charges and the charges overflow from the photoelectric conversion element 311 to the FD 314, thereby causing a decrease in potential of the FD 314 subjected to the FD reset. A long dashed short dashed line in the drawing indicates variations in potential of the FD 314 when weak sunlight that causes a relatively small amount of charges to overflow is incident. A dotted line in the drawing indicates variations in potential of the FD 314 when strong sunlight that causes a relatively large amount of charges to overflow is incident.

When weak sunlight is incident, the reset level is dropping at timing T3 that is the end of the FD reset, but the level does not fully drop at this time.

On the other hand, when strong sunlight is incident, the reset level fully drops at timing T3. In this case, the signal level becomes the same as the reset level, and the potential difference between the signal level and the reset level becomes “0”, so that the digital signal subjected to the CDS processing becomes the same as a digital signal in a dark state and sinks into black. As described above, a phenomenon in which the pixel becomes black even though very high intensity light such as sunlight is incident is called a black spot phenomenon or blooming.

Furthermore, when the level of the FD 314 of the pixel in which the black spot phenomenon has occurred is too low, the operating point of the pre-stage circuit 310 cannot be secured, and the current id1 of the current source transistor 316 varies accordingly. Since the current source transistor 316 of each pixel is connected to a common power supply or ground, when a certain pixel suffers variations in current, variations in IR drop in the pixel affect a sample level of another pixel. A pixel in which the black spot phenomenon occurs becomes an aggressor, and a pixel in which the sample level varies in a manner that depends on the pixel (aggressor) becomes a victim. As a result, streaking noise occurs.

Note that, in a case where the discharge transistor 317 is provided as in the sixth embodiment, in a pixel suffering a black spot (blooming), overflow charges are discharged toward the discharge transistor 317, so that the black spot phenomenon is less likely to occur. However, even if the discharge transistor 317 is provided, some charges may flow to the FD 314, and there is a possibility that the black spot phenomenon is difficult to get rid of completely. Further, there is also a disadvantage that a ratio of the effective area/the charge amount for each pixel decreases due to the addition of the discharge transistor 317. It is therefore desirable to suppress the black spot phenomenon without using the discharge transistor 317.

As a method for suppressing the black spot phenomenon without using the discharge transistor 317, there are two possible methods. The first is adjustment of a clip level of the FD 314. The second is a method in which whether or not the black spot phenomenon has occurred at the time of reading is determined, and when the black spot phenomenon has occurred, the output is replaced with the full code.

Under the first method, the high level of the FD reset signal rst (in other words, the gate of the FD reset transistor 313) in the drawing corresponds to the power supply voltage VDD, and the low level corresponds to the clip level of the FD 314. In the first embodiment, a difference between the high level and the low level (that is, amplitude) is set to a value corresponding to a dynamic range. On the other hand, in the fifth embodiment, the value is adjusted to a value plus an additional margin. Here, the value corresponding to the dynamic range corresponds to a difference between the power supply voltage VDD and the potential of the FD 314 when the digital signal becomes the full code.

Lowering the gate voltage (the low level of the FD reset signal rst) when the FD reset transistor 313 is off makes it possible to prevent the FD 314 from being excessively lowered due to blooming and the operating point of the pre-stage amplification transistor 315 from being lost.

Note that the dynamic range varies in a manner that depends on the analog gain of the ADC. When the analog gain is low, the dynamic range needs to be larger, and on the other hand, when the analog gain is high, the dynamic range can be less. It is therefore possible to change the gate voltage when the FD reset transistor 313 is off in accordance with the analog gain.

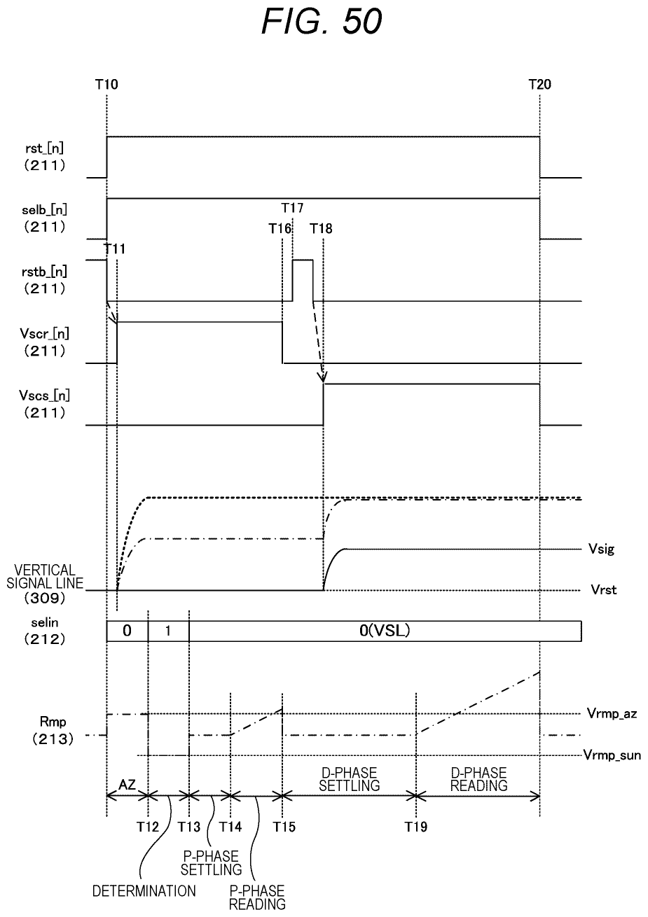

FIG. 50 is a timing chart illustrating an example of a read operation according to the ninth embodiment of the present technology. When the scan signal Vscr goes to a high level at timing T11 immediately after timing T10 at which reading is started, the potential of the vertical signal line 309 fluctuates in the pixel on which sunlight is incident. A long dashed short dashed line in the drawing indicates variations in potential of the vertical signal line 309 when weak sunlight is incident. A dotted line in the drawing indicates variations in potential of the vertical signal line 309 when strong sunlight is incident.

In an auto-zero period from timing T10 to timing T12, the timing control circuit 212 supplies, for example, the input-side selection signal selin of “0” to connect the comparator element 285 to the vertical signal line 309. Within this auto-zero period, the timing control circuit 212 performs auto-zeroing using the auto-zero signal Az.

Under the second method, the timing control circuit 212 supplies, for example, the input-side selection signal selin of “1” within a determination period from timing T12 to timing T13. The input-side selection signal selin disconnects the comparator element 285 from the vertical signal line 309 and connects the comparator element 285 to the node of the reference voltage VREF. The reference voltage VREF is set to an expected value of the level of the vertical signal line 309 when blooming does not occur. For example, when the gate-source voltage of the post-stage amplification transistor 351 is denoted as Vgs2, Vrst corresponds to Vreg-Vgs2. Furthermore, the DAC 213 lowers the level of the ramp signal Rmp from Vrmp_az to Vrmp_sun within the determination period.

In addition, in a case where blooming does not occur within the determination period, the reset level Vrst of the vertical signal line 309 is almost the same as the reference voltage VREF, and is not much different from when the potential of the inverting input terminal (+) of the comparator element 285 is auto-zero. On the other hand, since the non-inverting input terminal (−) lowers from Vrmp_az to Vrmp_sun, the comparison result VCO becomes the high level.

Conversely, in a case where blooming occurs, the reset level Vrst becomes sufficiently higher than the reference voltage VREF, and the comparison result VCO becomes the low level when the following expression is satisfied.

Vrst−VREF>Vrmp_az-Vrmp_sun Expression 5

That is, the timing control circuit 212 can determine whether or not blooming has occurred on the basis of whether or not the comparison result VCO becomes the low level within the determination period.

Note that it is necessary to secure some large margin for sun determination (the right side of Expression 5) so as to prevent erroneous determination due to variations in threshold voltage of the post-stage amplification transistor 351, IR drop differences of the in-plane Vreg, or the like.

After timing T13 that is the end of the determination period, the timing control circuit 212 connects the comparator element 285 to the vertical signal line 309. In addition, after the end of a P-phase settling period from timing T13 to timing T14, the P-phase is read within a period from timing T14 to timing

T15. After the end of a D-phase settling period from timing T15 to timing T19, the D-phase is read within a period from timing T19 to timing T20.

In a case of determining that blooming has not occurred in the determination period, the timing control circuit 212 controls the selector 292 in accordance with the output-side selection signal selout to output the digital signal CDS_out subjected to the CDS processing as it is.

On the other hand, in a case of determining that blooming has occurred over the determination period, the timing control circuit 212 controls the selector 292 in accordance with the output-side selection signal selout to output the full code FULL instead of the digital signal CDS_out subjected to the CDS processing. It is therefore possible to suppress the black spot phenomenon.

Note that the first and second modifications and the second to eighth embodiments of the first embodiment can be applied to the ninth embodiment.

As described above, according to the ninth embodiment of the present technology, since the timing control circuit 212 determines whether or not the black spot phenomenon has occurred on the basis of the comparison result VCO, and outputs the full code when the black spot phenomenon has occurred, it is possible to suppress the black spot phenomenon.

### 10. 10th Embodiment

In the first embodiment described above, the vertical scanning circuit 211 performs control to simultaneously expose all the rows (all the pixels) (that is, the global shutter operation). In a case where the simultaneity of exposure is not required, but low noise is required, such as at the time of test or analysis, it is, however, desirable to perform a rolling shutter operation. A solid-state imaging element 200 of this 10th embodiment is different from the solid-state imaging element 200 of the first embodiment in that the rolling shutter operation is performed at the time of test or the like.

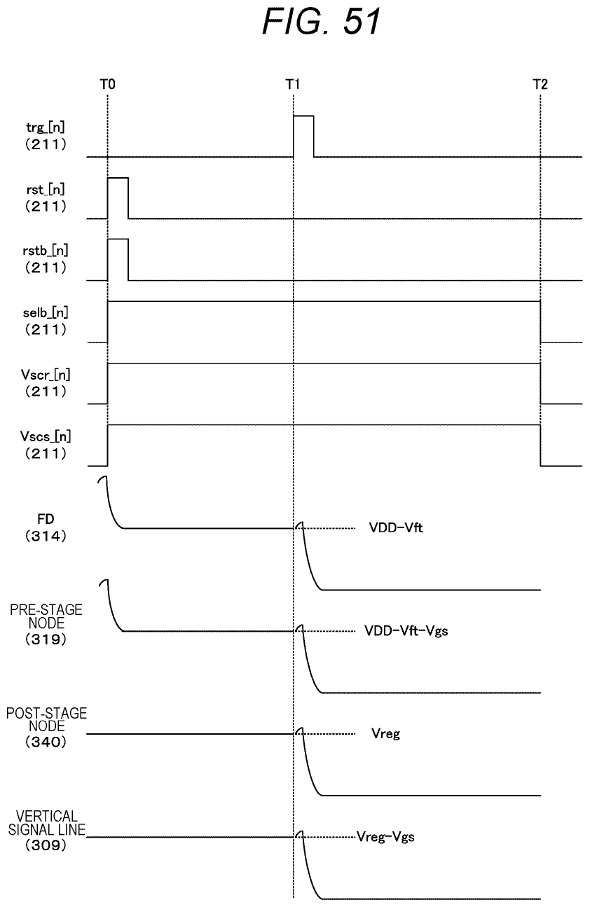

FIG. 51 is a timing chart illustrating an example of the rolling shutter operation according to the 10th embodiment of the present technology. The vertical scanning circuit 211 performs control to sequentially select a plurality of rows and start exposure. The drawing illustrates exposure control of the n-th row.

During the period from timing T0 to T2, the vertical scanning circuit 211 supplies the high-level post-stage selection signal selb and the scan signals Vscr and Vscs to the n-th row. Furthermore, at timing T0 that is the start of exposure, the vertical scanning circuit 211 supplies the high-level FD reset signal rst and the high-level post-stage reset signal rstb to the n-th row over the pulse period. At timing T1 that is the end of exposure, the vertical scanning circuit 211 supplies the transfer signal trg to the n-th row. The rolling shutter operation in the drawing allows the solid-state imaging element 200 to generate low-noise image data.

Note that, during normal imaging, the solid-state imaging element 200 of the 10th embodiment performs the global shutter operation in a manner similar to the first embodiment.

In addition, the first and second modifications of the first embodiment and the second to ninth embodiments can be applied to the 10th embodiment.

As described above, according to the 10th embodiment of the present technology, since the vertical scanning circuit 211 performs control to sequentially select a plurality of rows and start exposure (that is, the rolling shutter operation), it is possible to generate low-noise image data.

### 11. 11th Embodiment

In the first embodiment described above, the source of the pre-stage source follower (the pre-stage amplification transistor 315 and the current source transistor 316) is connected to the power supply voltage VDD, and row-by-row reading is performed with the source follower in the on state. There is, however, a possibility that this driving method causes circuit noise of the pre-stage source follower at the time of row-by-row reading to propagate to the subsequent stages, and random noise increases accordingly. A solid-state imaging element 200 of this 11th embodiment is different from the solid-state imaging element 200 of the first embodiment in that the pre-stage source follower is brought into the off state at the time of reading to reduce noise.

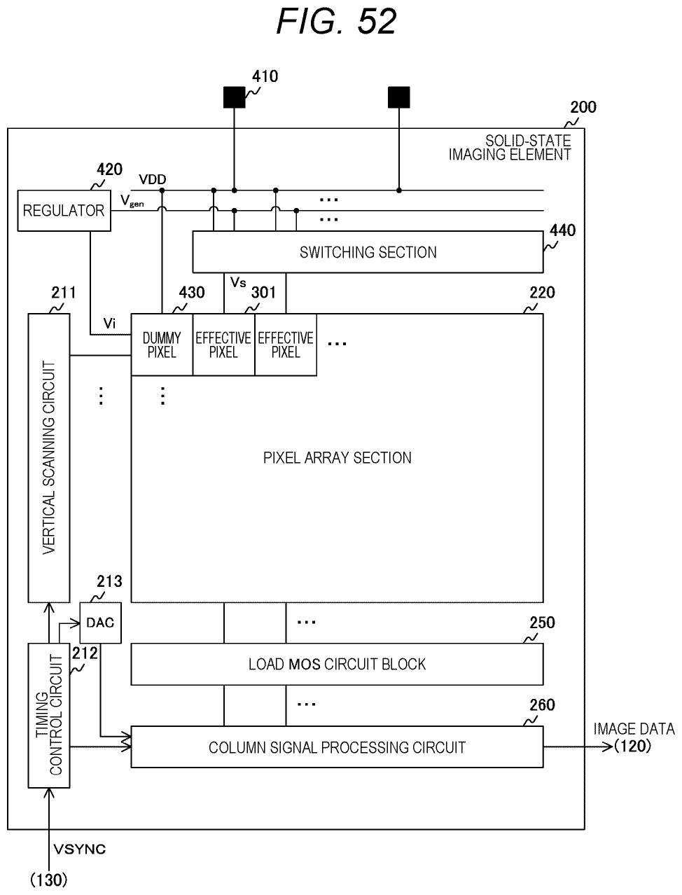

FIG. 52 is a block diagram illustrating a configuration example of the solid-state imaging element 200 according to the 11th embodiment of the present technology. The solid-state imaging element 200 of this 11th embodiment is different from the solid-state imaging element 200 of the first embodiment in that a regulator 420 and a switching section 440 are further provided. Furthermore, in the pixel array section 220 of the 11th embodiment, a plurality of effective pixels 301 and a predetermined number of dummy pixels 430 are arranged. The dummy pixels 430 are arranged around a region where the effective pixels 301 are arranged.

Furthermore, the power supply voltage VDD is supplied to each of the dummy pixels 430, and the power supply voltage VDD and a source voltage Vs are supplied to each of the effective pixels 301. A signal line through which the power supply voltage VDD is supplied to the effective pixels 301 is omitted in the drawing. Furthermore, the power supply voltage VDD is supplied from a pad 410 located outside the solid-state imaging element 200.

The regulator 420 generates a constant generated voltage Vgen on the basis of an input potential Vi from the dummy pixel 430 and supplies the generated voltage Vgen to the switching section 440. The switching section 440 selects either the power supply voltage VDD from the pad 410 or the generated voltage Vgen from the regulator 420, and supplies the selected voltage as the source voltage Vs to each of the columns of the effective pixels 301.

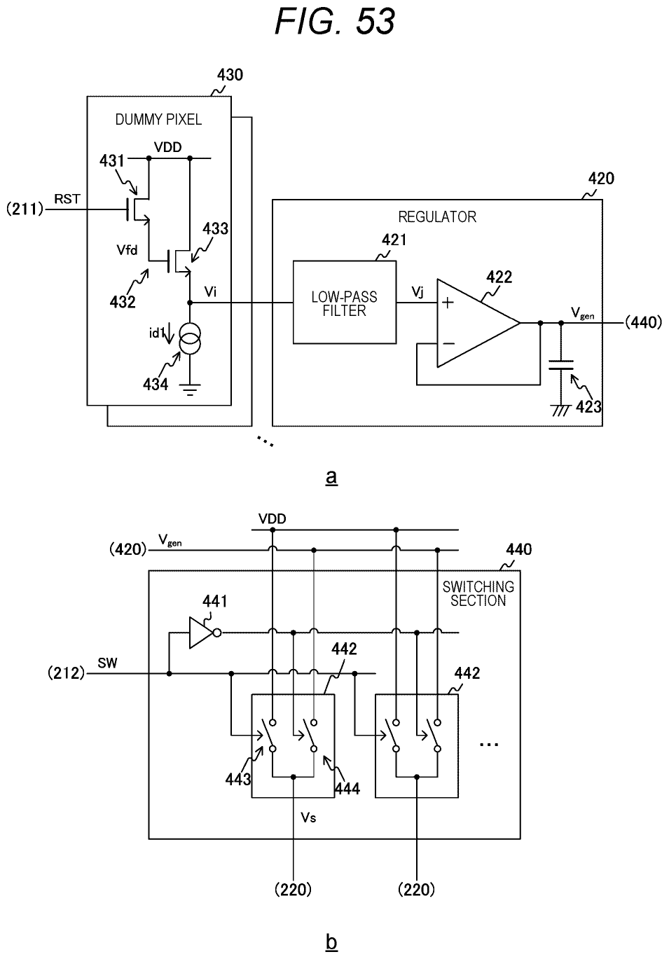

FIG. 53 is a circuit diagram illustrating a configuration example of the dummy pixel 430, the regulator 420, and the switching section 440 according to the 11th embodiment of the present technology. Of the drawing, a indicates a circuit diagram of the dummy pixel 430 and the regulator 420, and b of the drawing indicates a circuit diagram of the switching section 440.

As illustrated in a of the drawing, the dummy pixel 430 includes a reset transistor 431, an FD 432, an amplification transistor 433, and a current source transistor 434. The reset transistor 431 initializes the FD 432 in accordance with a reset signal RST from the vertical scanning circuit 211. The FD 432 accumulates charges, and generates a voltage corresponding to a charge amount. The amplification transistor 433 amplifies a level of a voltage of the FD 432 and supplies the amplified voltage as the input voltage Vi to the regulator 420.

Furthermore, the FD reset transistor 431 and the amplification transistor 433 have their respective sources connected to the power supply voltage VDD. The current source transistor 434 is connected to a drain of the amplification transistor 433. The current source transistor 434 supplies the current id1 under the control of the vertical scanning circuit 211.

The regulator 420 includes a low-pass filter 421, a buffer amplifier 422, and a capacitor element 423. The low-pass filter 421 passes, as an output voltage Vj, a component in a low-frequency band below a predetermined frequency out of a signal of the input voltage Vi.

The output voltage Vj is input to a non-inverting input terminal (+) of the buffer amplifier 422. An inverting input terminal (−) of the buffer amplifier 422 is connected to an output terminal of the buffer amplifier 422. The capacitor element 423 holds a voltage of the output terminal of the buffer amplifier 422 as Vgen. This Vgen is supplied to the switching section 440.

As illustrated in b of the drawing, the switching section 440 includes an inverter 441 and a plurality of switching circuits 442. The switching circuits 442 are each arranged for a corresponding one of the columns of the effective pixels 301.

The inverter 441 inverts a switching signal SW sent from the timing control circuit 212. The inverter 441 supplies the inverted signal to each of the switching circuits 442.

The switching circuit 442 selects either the power supply voltage VDD or the generated voltage Vgen and supplies the selected voltage as the source voltage Vs to the corresponding column in the pixel array section 220. The switching circuit 442 includes switches 443 and 444. The switch 443 opens and closes a path between the node of the power supply voltage VDD and the corresponding column in accordance with the switching signal SW. The switch 444 opens and closes a path between the node of the generated voltage Vgen and the corresponding column in accordance with the inverted signal of the switching signal SW.

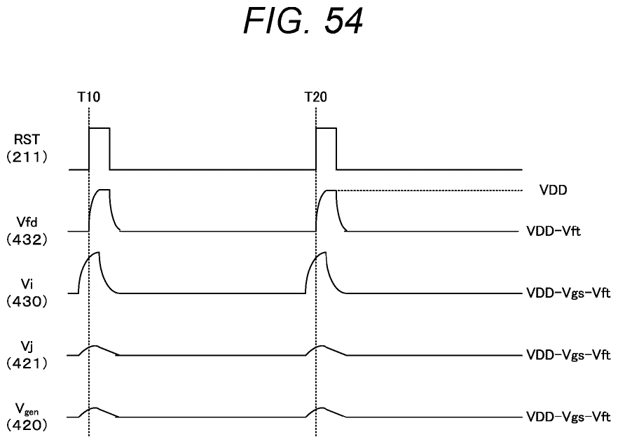

FIG. 54 is a timing chart illustrating an example of how the dummy pixel 430 and the regulator 420 operate according to the 11th embodiment of the present technology. At timing T10 immediately before reading of a certain row, the vertical scanning circuit 211 supplies a high-level reset signal RST (here, the power supply voltage VDD) to each of the dummy pixels 430. A potential Vfd of the FD 432 in the dummy pixel 430 is initialized to the power supply voltage VDD. Then, when the reset signal RST becomes the low level, reset feedthrough causes a change to VDD−Vft.

Furthermore, the input voltage Vi decreases to VDD−Vgs−Vsig after the reset. Passing through the low-pass filter 421 makes Vj and Vgen almost constant.

After timing T20 immediately before reading of the next row, similar control is performed for each row, and the constant generated voltage Vgen is supplied.

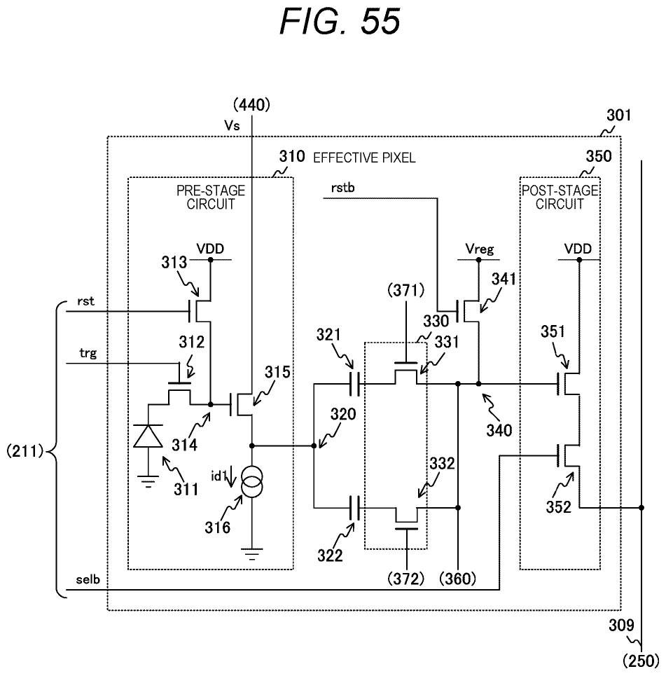

FIG. 55 is a circuit diagram illustrating a configuration example of the effective pixel 301 according to the 11th embodiment of the present technology. The effective pixel 301 is similar in circuit configuration to the pixel 300 of the first embodiment except that the source voltage Vs from the switching section 440 is supplied to the source of the pre-stage amplification transistor 315.

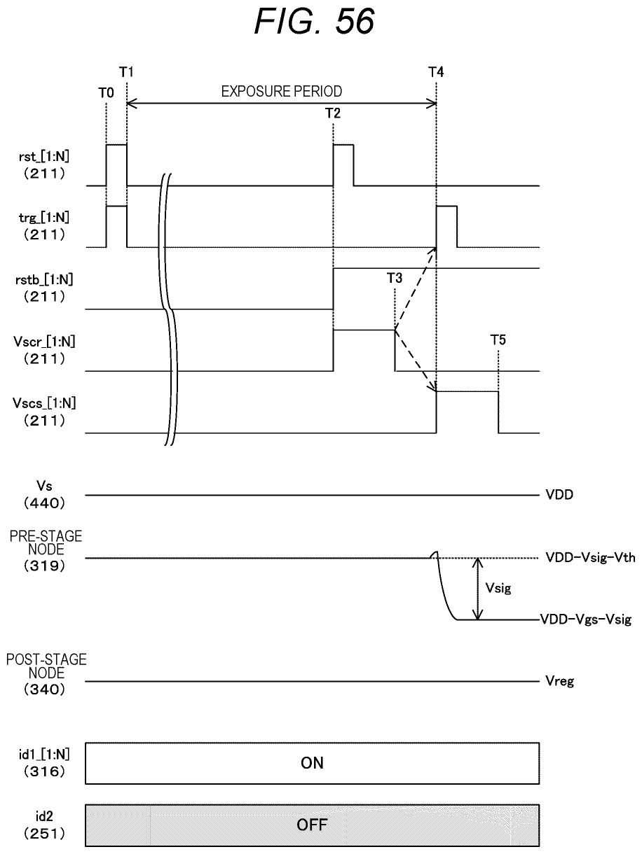

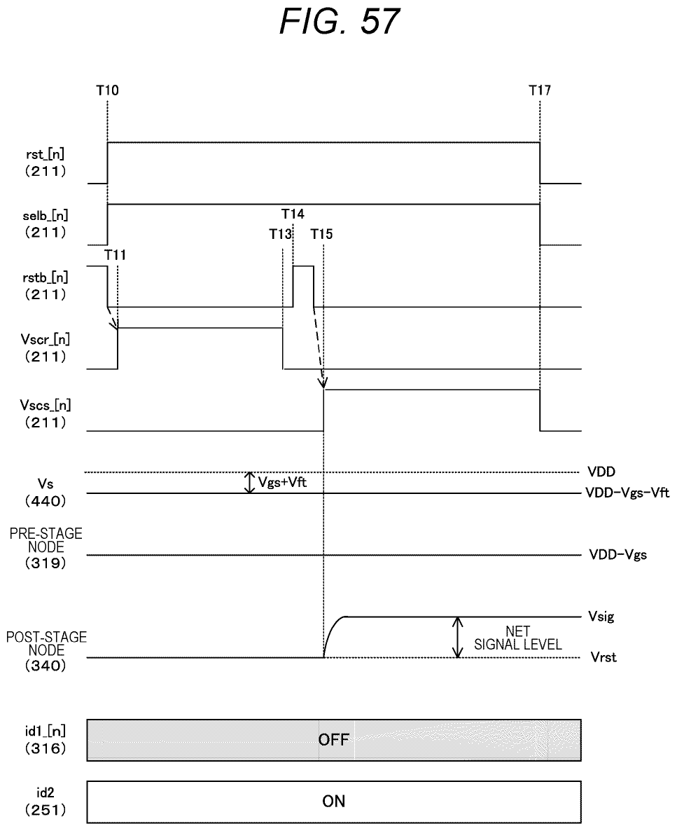

FIG. 56 is a timing chart illustrating an example of a global shutter operation according to the 11th embodiment of the present technology. In the 11th embodiment, when all the pixels are exposed simultaneously, the switching section 440 selects the power supply voltage VDD and supplies the power supply voltage VDD as the source voltage Vs. Furthermore, the voltage of the pre-stage node decreases from VDD-Vgs-Vth to VDD-Vgs-Vsig at timing T4. Here, Vth represents a threshold voltage of the transfer transistor 312.

FIG. 57 is a timing chart illustrating an example of a read operation according to the 11th embodiment of the present technology. In the 11th embodiment, at the time of reading, the switching section 440 selects the generated voltage Vgen and supplies the generated voltage Vgen as the source voltage Vs. The generated voltage Vgen is adjusted to VDD-Vgs-Vft. Furthermore, in the 11th embodiment, the vertical scanning circuit 211 controls the current source transistors 316 of all the rows (all the pixels) to stop the supply of the current id1.

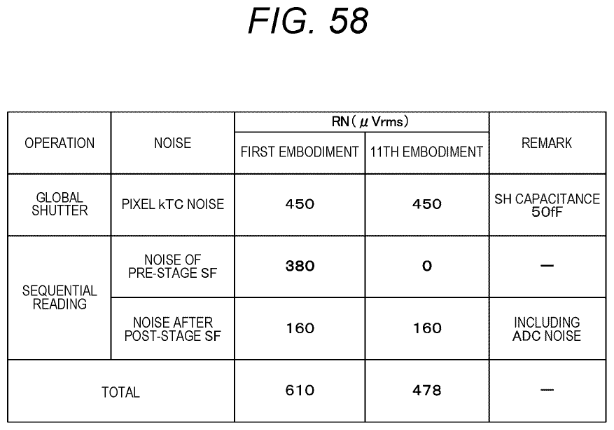

FIG. 58 is a diagram for explaining effects according to the 11th embodiment of the present technology. In the first embodiment, the source follower (the pre-stage amplification transistor 315 and the current source transistor 316) of the pixel 300 to be read is turned on during row-by-row reading. There is, however, a possibility that this driving method causes circuit noise of the pre-stage source follower to propagate to the subsequent stages (capacitor element, and post-stage source follower and ADC), and readout noise increases accordingly.

For example, in the first embodiment, as illustrated in the drawing, kTC noise generated in a pixel during the global shutter operation is 450 (μVrms). Furthermore, noise generated in the pre-stage source follower (the pre-stage amplification transistor 315 and the current source transistor 316) during the row-by-row reading is 380 φVrms). Noise generated in the pre-stage source follower and the subsequent stages is 160 (μVrms). Therefore, the total noise is 610 (μVrms). As described above, in the first embodiment, a proportion of the noise of the pre-stage source follower in the total noise becomes relatively large.

In order to reduce the noise of the pre-stage source follower in the 11th embodiment, the voltage (Vs) that can be adjusted is supplied to the source of the pre-stage source follower as described above. During the global shutter (exposure) operation, the switching section 440 selects the power supply voltage VDD and supplies the selected power supply voltage as the source voltage Vs. Then, after the end of exposure, the switching section 440 switches the source voltage Vs to VDD-Vgs-Vft. Furthermore, the timing control circuit 212 turns on the pre-stage current source transistor 316 during the global shutter (exposure) operation, and turns off the pre-stage current source transistor 316 after the end of exposure.

As illustrated in FIGS. 56 and 57, the above-described control makes the potential of the pre-stage node during the global shutter operation and the potential during the row-by-row reading identical to each other and thus allows an improvement in PRNU.

Furthermore, since the pre-stage source follower is in the off state during the row-by-row reading, circuit noise of the source follower does not occur and becomes zero φVrms) as illustrated in FIG. 58. Note that, in the pre-stage source follower, the pre-stage amplification transistor 315 is in the on state.

As described above, according to the 11th embodiment of the present technology, since the pre-stage source follower is brought into the off state at the time of reading, noise generated in the source follower can be reduced.

### 12. Application Example to Mobile Body

The technology according to the present disclosure (present technology) can be applied to various products. For example, the technology according to the present disclosure may be achieved in the form of a device to be mounted on a mobile body of any kind, such as an automobile, an electric vehicle, a hybrid electric vehicle, a motorcycle, a bicycle, a personal mobility, an airplane, a drone, a vessel, or a robot.

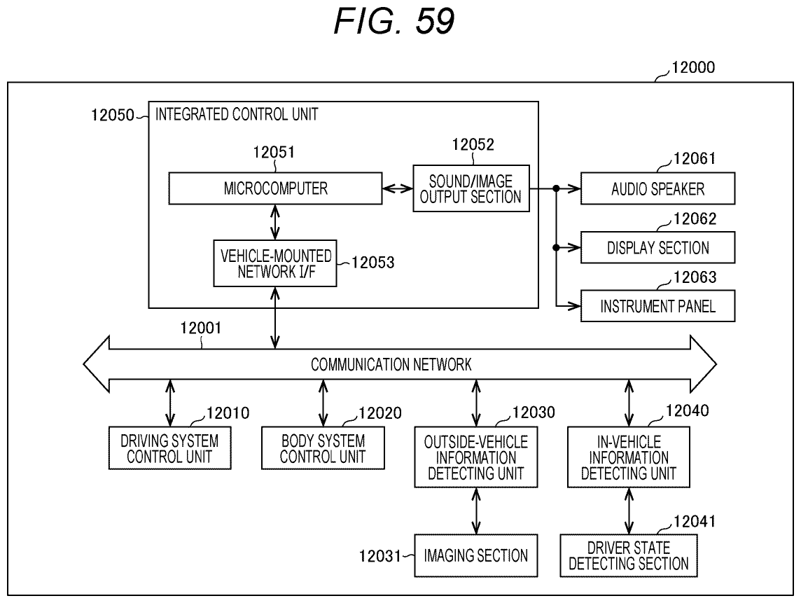

FIG. 59 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 59, the vehicle control system 12000 is provided with a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs.

For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 59, an audio speaker 12061, a display section 12062, and an instrument panel 12063 are illustrated as the output device. The display section 12062 may, for example, include at least one of an on-board display and a head-up display.

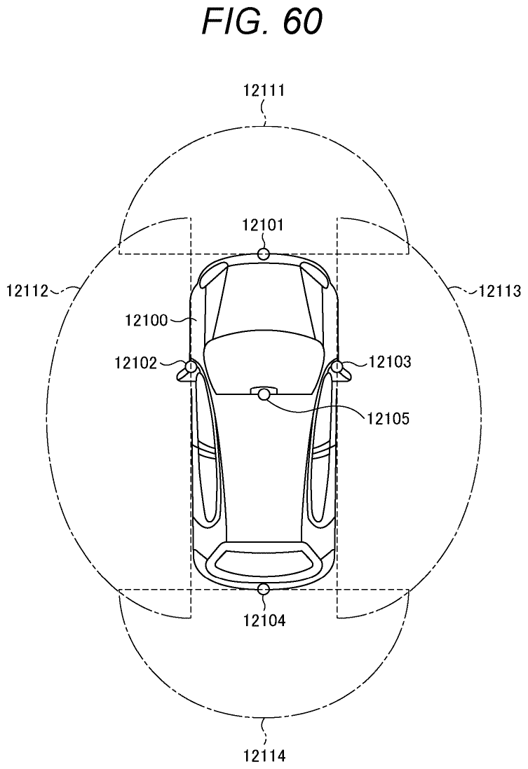

FIG. 60 is a diagram illustrating an example of the installation position of the imaging section 12031.

In FIG. 60, the imaging section 12031 includes imaging sections 12101, 12102, 12103, 12104, and 12105.

The imaging sections 12101, 12102, 12103, 12104, and 12105 are provided, for example, at positions such as a front nose, a sideview mirror, a rear bumper, a back door, an upper portion, and the like of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors acquire mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 60 illustrates an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure may be applied to the imaging section 12031 in the configuration described above. Specifically, for example, the imaging device 100 in FIG. 1 can be applied to the imaging section 12031. By applying the technology according to the present disclosure to the imaging section 12031, power consumption can be reduced.

Note that the embodiments described above illustrate examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the scope of the present technology.

Note that advantageous effects described in the present specification are merely examples and are not limited, and other advantageous effects may be provided.

Note that the present technology may also have the following configurations.
(1) A solid-state imaging element including:
a pre-stage circuit that generates a pixel signal that is an analog signal a plurality of times;
a sample hold circuit that holds a level of the pixel signal as a held value and updates the held value according to a level of a new pixel signal according to a determination signal predetermined; and
a determination circuit that determines whether or not to update the held value and supplies a signal indicating a determination result as the determination signal.
(2) The solid-state imaging element according to (1), in which
the determination circuit compares the pixel signal with a predetermined threshold value and supplies a comparison result as the determination result.
(3) The solid-state imaging element according to (2), in which
the pre-stage circuit, the sample hold circuit, and the determination circuit are arranged in each of a plurality of pixels.
(4) The solid-state imaging element according to (2), in which
the pre-stage circuit and the sample hold circuit are arranged in each of a plurality of pixels,
a pixel array section in which the plurality of pixels is arranged is divided into a predetermined number of regions,
the determination circuit is arranged in each of the regions, and
the pixels in the region share the determination circuit corresponding to the region.
(5) The solid-state imaging element according to (2) or (3), further including
a logic gate that supplies a predetermined scan signal indicating a sample timing and a read timing to the sample hold circuit on the basis of the determination signal,
in which the determination circuit includes:
a comparator that compares the pixel signal with a predetermined threshold value and supplies a signal indicating a comparison result as the determination signal; and
a latch circuit that captures and holds the determination signal at the sample timing and initializes the determination signal at the read timing.
(6) The solid-state imaging element according to (2) or (3), further including:
a pre-stage logic gate that supplies a predetermined scan signal indicating a sample timing on the basis of the determination signal; and
a post-stage logic gate that supplies a logical sum of a predetermined control signal indicating a read timing and an output signal of the pre-stage logic gate to the sample hold circuit.
(7) The solid-state imaging element according to (1), further including
an analog-to-digital converter that converts the pixel signal into a digital signal, in which
the determination circuit compares the digital signal with a predetermined threshold value and supplies a comparison result as the determination result.
(8) The solid-state imaging element according to any one of (1) to (7), in which
the pre-stage circuit is arranged on a predetermined first chip, and
the sample hold circuit is arranged on a predetermined second chip.
(9) The solid-state imaging element according to (8), in which
the determination circuit is arranged on the second chip.
(10) The solid-state imaging element according to (8), in which
the determination circuit is arranged on the first chip.
(11) The solid-state imaging element according to any one of (1) to (10), further including
a post-stage reset transistor that initializes a level of a predetermined post-stage node,
in which the pre-stage circuit sequentially generates a predetermined reset level and a signal level corresponding to an exposure amount,
the sample hold circuit includes:
first and second capacitor elements; and
a selection circuit that sequentially performs control to connect one of the first and second capacitor elements to the post-stage node, control to disconnect both the first and second capacitor elements from the post-stage node, and control to connect another of the first and second capacitor elements to the post-stage node, and
the post-stage reset transistor initializes a level of the post-stage node when both the first and second capacitor elements are disconnected from the post-stage node.
(12) An imaging device including:
a pre-stage circuit that generates a pixel signal that is an analog signal a plurality of times;
a sample hold circuit that holds a level of the pixel signal as a held value and updates the held value according to a level of a new pixel signal according to a determination signal predetermined; and
a determination circuit that determines whether or not to update the held value and supplies a signal indicating a determination result as the determination signal.
(13) The imaging device according to (12), in which
the pre-stage circuit and the sample hold circuit are arranged in each of a plurality of pixels, and
the determination circuit determines a pixel in a region of a focused subject among the plurality of pixels as a pixel whose held value is not updated.
(14) A method for controlling a solid-state imaging element, the method including:
a pre-stage procedure of generating a pixel signal that is an analog signal a plurality of times;
a sample and hold procedure of holding a level of the pixel signal as a held value and updating the held value according to a level of a new pixel signal according to a determination signal predetermined; and
a determination procedure of determining whether or not to update the held value and supplying a signal indicating a determination result as the determination signal.

### REFERENCE SIGNS LIST

100 Imaging device
110 Optical section
120 DSP circuit
121 Interface
122 Image processing section
123 Focus control section
124, 264 Determination result holding section
130 Display section
140 Bus
150 Operation section
160 Storage section
170 Power supply section
200 Solid-state imaging element
201 Upper pixel chip
202 Lower pixel chip
203 Circuit chip
211 Vertical scanning circuit
212 Timing control circuit
213 DAC
220 Pixel array section
221 Upper pixel array section
222 Lower pixel array section
250 Load MOS circuit block
251 Load MOS transistor
260 Column signal processing circuit
261 AD conversion section
262, 270 ADC
263, 360 Determination circuit
265, 290 Digital signal processing section
271 Counter
280 Comparator
281, 292 Selector
282, 283, 321, 322, 423 Capacitor element
284, 286 Auto-zero switch
285 Comparator element
291 CDS processing section
300 Pixel
301 Effective pixel
310 Pre-stage circuit
311 Photoelectric conversion element
312 Transfer transistor
313 FD reset transistor
314, 432 FD
315 Pre-stage amplification transistor
316, 434 Current source transistor
317 Discharge transistor
320 Sample hold circuit
323 Pre-stage reset transistor
324 Pre-stage selection transistor
330 Selection circuit
331, 332 Selection transistor
341 Post-stage reset transistor
350 Post-stage circuit
351 Post-stage amplification transistor
352 Post-stage selection transistor
361 Comparator
362, 375 Latch circuit
371, 372 AND (logical product) gate
373, 374 OR (logical sum) gate
420 Regulator
421 Low-pass filter
422 Buffer amplifier
430 Dummy pixel
431 Reset transistor
433 Amplification transistor
440 Switching section
441 Inverter
442 Switching circuit
443, 444 Switch
12031 Imaging section

1. A solid-state imaging element comprising:
a pre-stage circuit that generates a pixel signal that is an analog signal a plurality of times;
a sample hold circuit that holds a level of the pixel signal as a held value and updates the held value according to a level of a new pixel signal according to a determination signal predetermined; and
a determination circuit that determines whether or not to update the held value and supplies a signal indicating a determination result as the determination signal.

2. The solid-state imaging element according to claim 1, wherein
the determination circuit compares the pixel signal with a predetermined threshold value and supplies a comparison result as the determination result.

3. The solid-state imaging element according to claim 2, wherein
the pre-stage circuit, the sample hold circuit, and the determination circuit are arranged in each of a plurality of pixels.

4. The solid-state imaging element according to claim 2, wherein
the pre-stage circuit and the sample hold circuit are arranged in each of a plurality of pixels,
a pixel array section in which the plurality of pixels is arranged is divided into a predetermined number of regions,
the determination circuit is arranged in each of the regions, and
the pixels in the region share the determination circuit corresponding to the region.

5. The solid-state imaging element according to claim 2, further comprising
a logic gate that supplies a predetermined scan signal indicating a sample timing and a read timing to the sample hold circuit on a basis of the determination signal,
wherein the determination circuit includes:
a comparator that compares the pixel signal with a predetermined threshold value and supplies a signal indicating a comparison result as the determination signal; and
a latch circuit that captures and holds the determination signal at the sample timing and initializes the determination signal at the read timing.

6. The solid-state imaging element according to claim 2, further comprising:
a pre-stage logic gate that supplies a predetermined scan signal indicating a sample timing on a basis of the determination signal; and
a post-stage logic gate that supplies a logical sum of a predetermined control signal indicating a read timing and an output signal of the pre-stage logic gate to the sample hold circuit.

7. The solid-state imaging element according to claim 1, further comprising
an analog-to-digital converter that converts the pixel signal into a digital signal,
wherein the determination circuit compares the digital signal with a predetermined threshold value and supplies a comparison result as the determination result.

8. The solid-state imaging element according to claim 1, wherein
the pre-stage circuit is arranged on a predetermined first chip, and
the sample hold circuit is arranged on a predetermined second chip.

9. The solid-state imaging element according to claim 8, wherein
the determination circuit is arranged on the second chip.

10. The solid-state imaging element according to claim 8, wherein
the determination circuit is arranged on the first chip.

11. The solid-state imaging element according to claim 1, further comprising
a post-stage reset transistor that initializes a level of a predetermined post-stage node,
wherein the pre-stage circuit sequentially generates a predetermined reset level and a signal level corresponding to an exposure amount,
the sample hold circuit includes:
first and second capacitor elements; and
a selection circuit that sequentially performs control to connect one of the first and second capacitor elements to the post-stage node, control to disconnect both the first and second capacitor elements from the post-stage node, and control to connect another of the first and second capacitor elements to the post-stage node, and
the post-stage reset transistor initializes a level of the post-stage node when both the first and second capacitor elements are disconnected from the post-stage node.

12. An imaging device comprising:
a pre-stage circuit that generates a pixel signal that is an analog signal a plurality of times;
a sample hold circuit that holds a level of the pixel signal as a held value and updates the held value according to a level of a new pixel signal according to a determination signal predetermined; and
a determination circuit that determines whether or not to update the held value and supplies a signal indicating a determination result as the determination signal.

13. The imaging device according to claim 12, wherein
the pre-stage circuit and the sample hold circuit are arranged in each of a plurality of pixels, and
the determination circuit determines a pixel in a region of a focused subject among the plurality of pixels as a pixel whose held value is not updated.

14. A method for controlling a solid-state imaging element, the method comprising:
a pre-stage procedure of generating a pixel signal that is an analog signal a plurality of times;
a sample and hold procedure of holding a level of the pixel signal as a held value and updating the held value according to a level of a new pixel signal according to a determination signal predetermined; and
a determination procedure of determining whether or not to update the held value and supplying a signal indicating a determination result as the determination signal.
